(19) United States
(12) Patent Application Publication
(10) Pub. No.: US 2013/0024377 A1
(43) Pub. Date: Jan. 24, 2013

(54) Methods And Systems For Securing Transactions And Authenticating The Granting Of Permission To Perform Various Functions Over A Network

(71) Applicant: Daryl Stong, Gray, ME (US)

(72) Inventor: Daryl Stong, Gray, ME (US)

(21) Appl. No.: 13/407,483

(22) Filed: Feb. 28, 2012

Related U.S. Application Data
(60) Provisional application No. 61/509,708, filed on Jul. 20, 2011.
(60) Provisional application No. 61/510,815, filed on Jul. 22, 2011.
(60) Provisional application No. 61/511,253, filed on Jul. 25, 2011.

(51) Int. Cl. G06Q 20/40; G06F 21/20

(52) U.S. Cl. 705/44; 726/4

(57) ABSTRACT

The present invention relates to a method of restricting access to perform a function over a network. In one variant, the network comprises at least one function server and a vault server, each having a processor and a memory. The vault server has stored within its memory a personal access vault. The personal access vault comprises at least an identifying code and at least one authorization code. The method comprises: transmitting to a function server a request to restrict access to a function; providing to the function server the identifying code of the personal access vault and a series of characters representing the function to the function server; and the function server identifying the function and placing the function in a restricted status; upon the function server placing the function in a restricted status, the function server awaits permission from the vault server prior to performing the function.

### CROSS-REFERENCES TO RELATED APPLICATIONS

The present application claims priority from U.S. Provisional Application Ser. No. 61/509,708 filed on Jul. 20, 2011, U.S. Provisional Application Ser. No. 61/510,815 filed on Jul. 22, 2011 and U.S. Provisional Application Ser. No. 61/511,253 filed on Jul. 25, 2011. Each provisional application is hereby incorporated herein by reference in its entirety.

### TECHNICAL FIELD

The present invention, in some embodiments thereof, relates to methods for securing transactions and authenticating the granting of permission to perform various functions over a network.

### BACKGROUND OF THE INVENTION

The current security methods utilized in online banking and many types of electronic financial transactions can be described as a wallet or safe. The term “wallet” has been popularized by companies like PayPal, Google and Amazon. The mobile wallet has become a popular way to pay for services and merchandise online and is becoming increasingly popular in offline transactions. It is anticipated that the use of mobile wallets will continue to grow in both online and offline transactions. One recent example is the addition of Google Wallet as a payment method at various physical retail locations.

The wallet, in general, can be described as a method for storing funds (“stored value” accounts) and payment methods behind an access code combination sequence and allowing access to the available funds and payment methods to anyone in possession of the access code combination sequence.

Access code combination sequence is defined here as the username, password and any additional security enhancements such as identifying pictures, key codes, etc.

Consumers utilizing wallets believe that transaction(s) initiated via a wallet are more convenient and “secure”. Wallets are in fact more convenient because the user only has to remember the correct access code combination sequence to unlock the wallet.

Wallets are further believed to be more secure because they prevent the “owner” of the wallet from having to enter credit card or bank account information on websites thereby decreasing the chances that the credit card or bank account numbers and authorization codes will be discovered by unauthorized individual(s).

The core vulnerability in this technology is that anyone in possession of the access code combination sequence now has the keys to the kingdom. Not only are they able to transfer funds from the stored value account, they are also able to access multiple other payment methods depending upon how many payment methods the owner has added to the wallet.

While each of the companies providing wallets employ different security enhancements, they all suffer from the same core flaw. Anyone obtaining the access code combination sequence is believed to be the wallet's rightful owner and therefore is allowed to make changes to the profile information, notification methods, add, withdraw and transfer funds to and from the stored value account and to and from some of the associated payment method(s).

FIG. 1, FIG. 2 and FIG. 3 illustrate this by using an actual method to send $1,000 to a fictional email address to-the-thieves@cyber-criminal-inc.com.PayPal would process this transaction immediately upon the website user clicking the “Send Money” button.

Central to PayPal's security enhancements is the method of requiring wallet owners to “confirm” payment methods added to the PayPal account. For each payment method to be added, the user is asked to enter specific account details. In the case of a bank account, the user is asked to provide a Bank ABA number and the account number.

PayPal then proceeds to deposit nominal amounts into the payment method(s) to be confirmed and attaches a security code to the deposits which will be visible to the user via their account history within their online banking access site. The wallet owner is advised to monitor the accounts and retrieve the amount of the deposits and the security codes once the amounts are posted to the payment method account(s).

At that time, the wallet owner is instructed to log back into their PayPal account. Click “confirm payment methods”, and proceed to enter the deposit amounts and corresponding security codes.

PayPal then verifies that the reported deposit amounts and codes match what PayPal has stored in its records. If a match is confirmed, the Payment method is added to the PayPal account and is now available as a means to fund the stored value account and transfer funds to third parties.

The major security flaw in this confirmation method is that should the user be using a computer that has a keystroke logger installed on it, they will expose multiple access code combination sequence(s) to the person(s) who installed the keystroke logging software. As this point, there is a high likelihood that this individual will become the victim of one or more cyber crimes.

This is not intended to be an indictment of the methods employed by PayPal as they follow standard conventions employed throughout online banking. In fact, PayPal provides strong assurances to their customers that they will not be held responsible for breaches of their PayPal accounts. PayPal accomplishes this by reimbursing customers for any losses incurred by unauthorized access to customer accounts.

It is however, intended to be an indictment of all currently employed online banking methods and almost all security measures employed for the transfer of information and authorization to take action on stored information in both online banking and real world scenarios.

The core flaw is as follows:

Anyone with knowledge of the access code combination sequence(s) is perceived to be the rightful owner of the information and is therefore allowed to initiate any number of actions based upon having knowledge of the access code combination sequence(s).

A further flaw is that any person with knowledge of the access code combination sequence(s) is now able to view the account information and take action to initiate changes to the information by way of adding payment method(s) deleting payment method(s), changing profile information and notification methods. Furthermore, they are able to initiate almost all actions within the account, which enable users to add, transfer and withdraw funds.

The access code combination sequence(s) can be thought of as a puzzle. Anyone correctly solving the puzzle is free to access the information and therefore take action based upon knowledge of the access code combination sequence(s)

A Rubik's Cube is a good analogy. A simple 2×2 Rubik's cube is relatively easy to solve. Additional cubes can be added thereby exponentially increasing the odds against successfully solving the puzzle. This principal has been widely employed in online banking. The belief is that by utilizing methods to increase the complexity of access code combination sequence(s),the security can be enhanced to the point where criminals will no longer gain access to the information.

Additional security methods include requiring the use of alpha-numeric symbols in passwords, removal of easily guessed words from passwords, secret questions, and the inclusion of previously selected images which the user must re-identify to gain access to account(s).

These additional security methods have proven to be less than effective as online bank fraud continues to be prevalent and may in fact be on the rise. Combating the problem in this manner will prove to be futile due to the following formula:

P*C=I

The variables are defined as follows:
P=the number of People with access to electronic networks, banking and other information systems.
C=the increasing power of networks and Computing.
I=Incidence of online and other types of information based crimes.

Access to computing and the Internet is exploding as individuals in emerging and frontier markets are coming online at an exponential rate.

While in this lies massive opportunities for both businesses and individuals; the threat from increasing risks associated with the unauthorized use of information needs to be addressed to allow the world to move forward without an exponential increase of risks to all parties.

What can be deduced from the above formula is as follows: Since access code combination sequences have been increased to the point where not even very powerful computers can “guess” the correct access code combinations, the problem is not Computers. Therefore, C is a known variable.

To solve this equation, P needs to be solved. The P is people with access or potential access to information that allows such individuals to initiate and very often successfully complete unauthorized transactions.

In short, the access code combination sequence method for securing information is outmoded and needs to be replaced with new methods for securing and accessing information of all kinds.

This Patent suggests systems & methods which once embodied will greatly enhance security in electronic and all types of real world informational systems. It will do so by suggesting a specific exemplary embodiment and will give specific details into how this embodiment may be iterated suggesting a number of further embodiments that may be employed in a relatively short period of time utilizing existing technologies and methods.

Furthermore, it suggests implementation methods whereby even those without the means or access to modern technology may be at least partially protected utilizing decades old equipment that is available even in many frontier and emerging markets.

The Patent shows how the exemplary embodiment would allow for all manner of requests for information-based transactions to be verified as originating from individuals authorized to make the requested transactions. It will further show that once embodied, this method would serve to greatly reduce all manner of criminal activity and further allow for the rapid detection and apprehension of criminals engaged in such activity.

Furthermore, this Patent will show that the exemplary embodiment could make the committing of information crimes so difficult that it will become unattractive to individuals contemplating such crimes thereby decreasing the number of individuals attracted to criminal activities in the first place.

The Patent will suggest an exemplary embodiment that once implemented will greatly enhance the speed, efficiency and security at which information is transmitted, verified and confirmed on electronic networks. It will further suggest ways to reduce the amount of information transmitted in the first place thereby decreasing the likelihood that sensitive information would fall into the hands of individual(s) with criminal or malicious intent.

Lastly, it will show how this method may be embodied to allow for the decrease in many types of “real world” crimes.

Prior to detailing the suggested methods, it will be helpful to take a closer look at the types of crimes associated with information theft.

FIG. 4 depicts a scenario where a person(s) gains unauthorized access to an online bank account. Uses the credentials to access the bank account though the online banking website and requests to transfer funds to an accomplice.

Referring to FIG. 4, a cyber criminal(s) 400 has obtained access codes to an online bank account and uses a device 401 to request the transfer of funds. An API Server 402 of the bank being is breached. The retrieval person's bank API server 403 and the retrieval person 404 are illustrated. A money transfer service 405 is used to transmit the funds back to the criminal after the retrieval person subtracts some portion in exchange for their services. The dotted lines depict the flow of information required to commit the crime while the solid lines depict the flow of funds. The access code combination sequence(s) required to commit this crime consist of the bank account username, password and possibly any number of one or more additional security code(s).

FIG. 5 is a depiction of a typical check fraud in which the criminal unlawfully obtains the check(s) or checking account numbers of a third party, impersonates said third party and proceeds to utilize the checks and perhaps stolen identification to initiate requests to transmit funds to themselves or other third party.

Referring to FIG. 5, a person 500 is in possession of stolen checks. An outlet 501 is where the check is used or cashed. The retail outlet's bank account 502 and the victim's bank account 503 are illustrated. The eventual discovery of crime 504 and subsequent charge against bank profits are illustrated. The dotted lines again depict the flow of information while the solid lines depict the flow of money. The access code combination sequence(s) required to commit this crime are the possession of the checks and perhaps falsified or stolen identification card(s).

FIG. 6 is a depiction of credit card fraud in an online transaction. A person 600 is illegally in possession of credit card(s) and/or number(s). A Retailer website 601, a retailer API Server 602, a Retailer's bank and/or merchant clearing bank 603 the victim's bank 604 are illustrated. Again, the dotted lines depict the flow of information while the solid lines depict the flow of money. The dashed lines show the subsequent charge off against the retailer profits upon discovery of crime by victim. The access code combination sequence(s) to commit the crime are being in possession of the stolen credit card information including account number, expiration date and in some cases CVV code.

FIG. 7 is a depiction of credit card fraud in a bricks and mortar transaction. A person 700 is illegally in possession of credit card(s). A Retailer POS transaction terminal 701, a Retailer's bank and/or merchant clearing bank 702 and a victim's bank 703 are illustrated. Again, the dotted lines depict the flow of information while the solid lines depict the flow of money. The dashed lines show the subsequent charge off against the retailer profits upon discovery of crime by the victim. The access code combination sequence(s) to commit the crime are being in possession of a stolen credit card, knowledge of access codes, signature and/or a fraudulent ID. It should be noted that retail outlet employees only infrequently verify signatures and ID's.

FIG. 8 is a depiction of a typical identity theft. An individual 800 is in possession of the victim's Social Security number. A credit grantor 801 and a credit reporting agency 802 are illustrated. A new line of credit 803 is opened utilizing the victim's identity. The dotted lines represent the transmission of information required to authorize the line of credit while the solid lines represent the funds being transferred to the new line of credit and subsequently withdrawn for use by the identity thief. The access code combination sequence(s) required to commit this crime are knowledge of the victim's Social Security number, date of birth and either stolen or falsified ID.

FIG. 9 is a depiction of the mass loss of credit card data from a retailer's server. A retailer's server 900 contains all types of consumer information. A customer credit card information and customer data 901 flows into the retailer's database for storage after a purchase is made at a retailer. An attacking server 902 is operated by the criminal enterprise or individual(s) seeking to gain access to card numbers and other personal consumer information. The dotted lines represent the flow of consumer information into the retailer's server. The dashed line represent the process required to breach the retailer server's firewall(s) and the solid lines represent the transfer of information to the criminal(s) server. The access code combination sequence(s) to commit this crime is the ability to breach the firewall of the retailer's server. This type of crime is happening with increasing frequency. One example is the Sony breach in April of 2011 in which 75 million credit card numbers may have been stolen.

The crimes described above represent a sampling of the crimes committed through information theft or unauthorized use of information and resources.

The solution to these problems is the Virtual Vault described herein.

### BRIEF SUMMARY OF EMBODIMENTS OF THE INVENTION

(1) The present invention relates to a method of restricting access to perform a function over a network. The network comprises at least one function server and a vault server, each having a processor and a memory. The vault server has stored within its memory a personal access vault. The personal access vault comprises at least an identifying code and at least one authorization code. The method comprises: transmitting to a function server a request to restrict access to a function; providing to the function server the identifying code of the personal access vault and a series of characters representing the function to the function server; and the function server identifying the function and placing the function in a restricted status; upon the function server placing the function in a restricted status, the function server awaits permission from the vault server prior to performing the function.

(2) In a variant, a method of granting a permission to perform a function over a network comprises at least one vault server and at least one function server, each having a processor and a memory. The vault server has stored within its memory at least one personal access vault. The network further comprises at least one communication device. The method comprises: sending the vault server a request for permission to perform the function; in response to receiving the request, the vault server transmitting to the communication device an authorization request; in response to receiving the authorization request, the communication device prompting an operator for the authorization; the operator indicating on the communication device the authorization and directing the communication device to transmit the authorization back to the vault server; in response to receiving the authorization, the vault server checking whether the authorization matches the authorizing code stored within the personal access vault; upon confirming a positive match between the authorization and the authorizing code, the vault server transmitting the permission to the function server; in response to receiving the permission, the function server performing the function. The vault server does not have the data or the authorization required to perform the function and the function server is not authorized to perform the function without first obtaining the permission from the vault server.

(3) In another variant, the method of granting a permission to perform a function further comprises indicating an authorizing code on a communication device, wherein malicious software, such as a keystroke logger, cannot readily determine the substance of the authorizing code, and the method further comprises: the communication device providing to the operator a plurality of patterns, each of the patterns consisting of a unique array of images, shapes, symbols, colors or characters; the communication device prompting the operator to select a pattern; upon selecting the pattern, the communication device prompting the operator to select the authorizing code by directing the operator to move a pointer to specific areas within the displayed pattern and, instructing the operator to click or tap within the displayed pattern a plurality of times; the operator completing the task of selecting the authorizing code and indicating to the device the completion of the task; upon the completion of the task, the device transmitting the pattern and the series of clicks or taps representing the authorization code to a processor; upon receiving the data, the processor interpreting the pattern and the series of clicks or taps to decipher the authorizing code; and the processor storing the authorizing code in a memory.

(4) In a further variant, the method of indicating an authorizing code on a communication further comprises the communication device rearranging in a random manner the array of images, shapes, symbols, colors or characters within a pattern each time an operator is prompted to enter the authorizing code. A malicious software having discovered the unique pattern would further have to determine the random arrangement of the images, shapes, symbols, colors or characters within the pattern in order to decipher the input activity on the communication device and gain knowledge of the authorizing code.

In still another variant, the method comprises an operator of a communication device selecting an authorizing code and transmitting the authorizing code to a vault server.

(5) In yet a further variant of the method of granting a permission to perform a function, the identifying code of a personal access vault is an internet address, email address or telephone number; the identifying code providing the information required to determine the location of a vault server and the location of a personal access vault within the memory of a vault server; and the location of a vault server is determined utilizing standard internet and telephony protocols.

(6) In a variant, the method of granting a permission to perform a function comprises in response to the receiving the request, the vault server transmitting to a communication device an authorization request via a predetermined communication channel.

(7) In another variant of the method of granting a permission to perform a function, the function server comprises a payment remittance server. The step of sending the vault server a request to perform the function, comprises: transmitting to the payment remittance server a request to process a payment; upon receiving the request, the payment remittance server checking a payment method account number to determine whether the account is in a restricted status; and if the account is in a restricted status, the payment remittance server sending a request to the vault server to grant a permission to process the payment.

(8) In a further variant, the step of transmitting to a payment remittance server a request to process a payment further comprises: the vault server sending to a communication device a list of available payment methods and prompting the operator to select a payment method; the device displaying each payment method in an abbreviated format to prevent from displaying the full identity of each payment method; the operator selecting a payment method and transmitting a selection back to the vault server; upon the vault server receiving the payment method selection, the vault server using the payment method selection to determine the location of a payment remittance server; and the vault server transmitting to the payment remittance server a request to process the payment. None of the steps in the method contain the payment method account numbers transmitted to or from the communication device and the communication device does not provide to the device operator any of the complete payment method account numbers.

(9) In still another variant, the step of transmitting to a payment remittance server a request to process a payment further comprises either a payee or a payer transmitting the request to process the payment to either a payment remittance server or a vault server.

(10) In yet a further variant, the step of either a payee or a payer transmitting the request to the payment remittance server further comprises: providing to a payee an identification code to a personal access vault, with the identification code allowing the payee to determine the location of a vault server; the payee sending to the vault server, the identification code and a request to process a payment; the vault server using the identification code to determine the location of the personal access vault within the vault server memory; the vault server performing a plurality of functions to obtain an authorization, a preferred payment method and the location of a payment remittance server; and the vault server transmitting to the payment remittance server a request to process the payment. None of the steps in the method comprise the payment method account numbers being transmitted and the vault server is not required to have the payment method account numbers to process and transmit the payment request.

(11) In a variant, the step of the vault server performing a plurality of functions to obtain an authorization, a preferred payment method and the location of a payment remittance server comprises: the vault server checking whether a preferred payment method is indicated within the personal access vault; if a preferred payment method is indicated, the vault server transmitting a request for payment to a payment remittance server; if the preferred payment method is not indicated, the vault server transmitting a request for a selection of payment method to a communication device along with a request for an authorization; the communication device prompting an operator to select a payment method and provide the authorization; and the operator selecting the payment method and providing the authorization. None of the steps in the method comprise the payment method account numbers transmitted to or from the communication device or to and from the payee.

(12) In another variant, the step of either a payee or a payer transmitting a request to process payment to a payment remittance server further comprises: providing to a payer a transaction code; the payer transmitting to a vault server the transaction code and an identification code of a personal access vault; the vault server utilizing the identification code to locate a personal access vault within the memory of the vault server; the vault server performing a plurality of functions to obtain an authorization, a preferred payment method, and the location of a payment remittance server; and the vault server transmitting to the payment remittance server a request for payment in combination with the transaction code. None of the steps in the method comprise the payment method account number being provided to the payee.

(13) In a further variant, the step of the vault server transmitting to the payment remittance server a request for payment comprises: upon the payment remittance server receiving a request for payment in combination with the transaction code, the payment remittance server utilizing the transaction code to determine the amount of a payment and the location of a payment acceptance server; and the payment remittance server sending the payment and the transaction code to a payment acceptance server.

(14) In still another variant, the step of the payment remittance server sending the payment and the transaction code to a payment acceptance server, further comprises: upon the payment acceptance server receiving the payment and the transaction code, the payment acceptance server utilizing the transaction code to determine the location of a financial account and a financial account number; and the payment acceptance server applying the payment to a financial account number.

(15) In yet a further variant, the step of the payment acceptance server applying the payment to a financial account number comprises: the payment acceptance server transmitting to payee a confirmation of the payment received along with the transaction code; the payee utilizing the transaction code to match the payment received to a transaction in process; and in response to receiving the confirmation of payment and the transaction code, the payee matching the transaction code to a transaction in process and allowing the transaction to proceed. None of the steps comprise: the identity of the payer, the payment method, or the payment method account number being transmitted to or from the payee.

(16) In another variant, the step of a payee providing to a payer a transaction code comprises: providing a transaction code to a communication device; upon receiving the transaction code, the communication device activates a software application; the software application providing to an operator of the communication device a request to process payment; the operator granting the request to process payment on the communication device; and the communication device transmitting the request to process payment to the vault server.

(17) In a further variant, the method comprises: imprinting upon a physical representation of a payment method the identification code of a personal access vault in combination with a payment method identification code, the payment method identification code being different from the payment method account number; providing to a payee the physical representation of the payment method; the payee transmitting a payment request via at least one payment network server; the payment network server utilizing the identification code of the personal access vault to determine the location of a vault server; and the payment network server transmitting a request for payment in combination with the payment method identification code to the vault server. None of the steps of the method comprise the payment method account number being printed upon the physical representation of the payment method.

(18) In still another variant, the method comprises: upon receiving a payment request in combination with an identification code for a personal access vault and payment method identification code, the vault server determining the location of a personal access vault; the vault server using the payment method identification code to determine the location of a payment remittance server; and the vault server transmitting a request to process payment to a payment remittance server. None of the steps of the method comprise the payment method account number being printed upon the physical representation of the payment method.

(19) In yet a further variant, the step of transmitting to a function server a request to restrict access to a function comprises: providing the vault server identifying details of the function and requesting that the access to the function be restricted; the vault server transmitting to the function server a request to restrict access to the function; the function server receiving the request to restrict access and restricting access; and the function server awaiting a permission from the vault server prior to performing the function.

(20) In a variant, the step of transmitting to the function server a request to restrict access to a function, further comprises: providing to a function server an identifying code for a personal access vault and requesting the function server to restrict access to a function; upon receipt of the request, the function server transmitting a notification to a vault server that the function is in a restricted state; the vault server transmitting a confirmation of receipt back to the function server; and the function server providing to an operator an icon indicating the restricted status of the function.

(21) In another variant, the method of processing a payment comprises: in response to receiving a request to process payment, the payment remittance server checking the payment method account to determine whether the account is in a restricted status; if the account is in a restricted status, the payment remittance server checking whether the amount of the payment requested is over a predetermined amount; and if the payment requested is over a predetermined amount, the payment remittance server sending a request to the vault server to grant a permission.

(22) In a further variant, the step of either a payee or a payer transmitting the request to process the payment to either a payment remittance server or a vault server comprises: the payer transmitting to a vault server a request to process a payment along with a identifying code for a payee personal access vault; the payer vault server transmitting the request to process the payment along with the identifying code of the payee personal access vault to a payment remittance server; the payment remittance server transmitting a request to the vault server hosting the payee personal access vault to transmit back an account identifying account code for the payee, the account code being different from the financial account number for the payee; the payee vault server transmitting back the account code to the payment remittance server; the payment remittance server utilizing the account code to determine the location of a payment acceptance server; the payment remittance server transmitting payment to the payment acceptance server along with the identifying code for the personal access vault and the account code received from the vault server of the payee; the payment acceptance server utilizing the identifying code of the personal access vault of the payee in combination with the account code to determine the financial account number for the payee; and the payment acceptance server depositing the funds into the financial account of the payee. None of the steps of the method comprise the payment method account number of the payer or the financial account number of the payee being transmitted to or from any vault server, payment acceptance server, or payment remittance server and, in none of the steps is a stored value account or the assistance of any third party payment processor required to transmit payment from the account of the payer to the account of the payee.

(23) In still another variant of the method of granting a permission to perform a function, a function may comprise one or more of the following: sending a vault server a request to transmit a credit report; sending the vault server a request to transmit a tax return;

sending the vault server a request to unlock a physical property; and sending the vault server a request to report a missing person; sending the vault server a request to enter a legal contract. The server processing the function does not have the authorization to process the function without first obtaining a permission from the vault server.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1, FIG. 2 and FIG. 3 illustrate how easily a PayPal® account can be used by criminals to drain funds from a user's PayPal® account;

FIG. 4 depicts a scenario where a person(s) gains unauthorized access to an online bank account;

FIG. 5 is a depiction of a typical check fraud transaction;

FIG. 6 is the depiction of credit card fraud in an online transaction;

FIG. 7 is a depiction of credit card fraud in a bricks and mortar transaction;

FIG. 8 is a depiction of a typical identity theft;

FIG. 9 is a depiction of the mass loss of credit card data from a retailer's server;

FIG. 10 is a depiction of a Virtual Vault;

FIG. 11 is a depiction of a successful retail credit or debit card transaction;

FIG. 12 is a depiction of a process for cancelling a retail credit or debit card transaction;

FIG. 13 is a depiction of a process for reporting lost or stolen credit card or debit card transaction;

FIG. 14 is a depiction of a request for credit report initiated on Credit Grantor Request Device process.

FIG. 15 is a depiction of a request to show ID initiated on Personal Request & Response device process;

FIG. 16 is a depiction of a process for “unlocking” physical property Request(s) on a Personal Request & Response Device;

FIG. 17 is a depiction of a Missing Child Report process;

FIG. 18 is a flow chart of a method for restricting access to perform a function over a network;

FIG. 19 is a flow chart of a variant of the method of restricting access to perform a function over a network;

FIG. 20 is a flow chart of another variant of the method of restricting access to perform a function over a network; and

FIG. 21 is a depiction of a method for selecting and indicating an authorizing code on an input device.

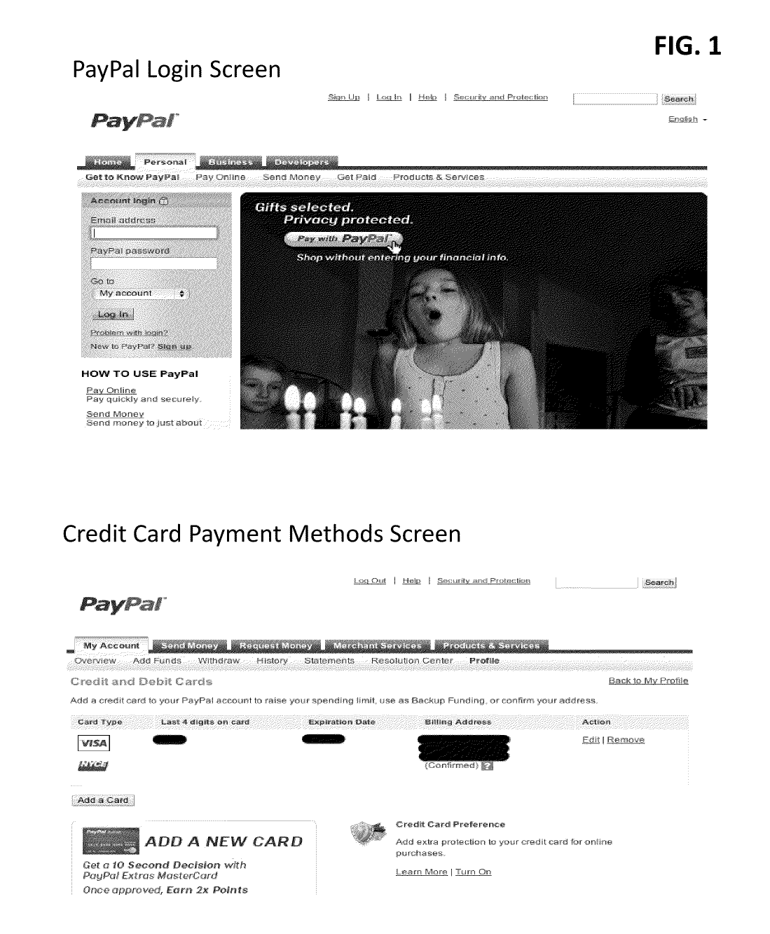

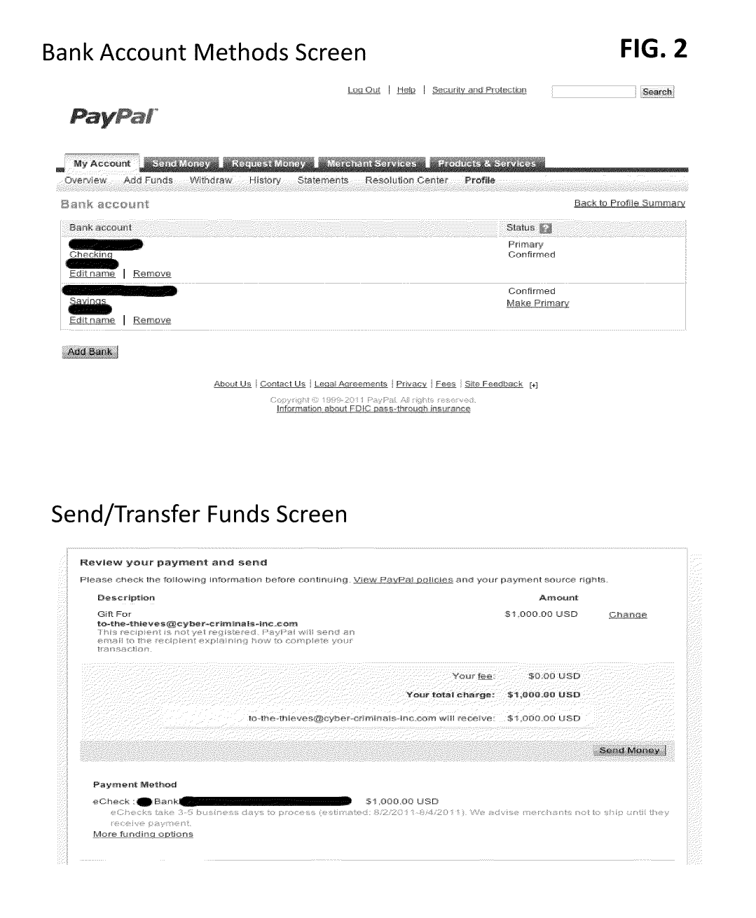

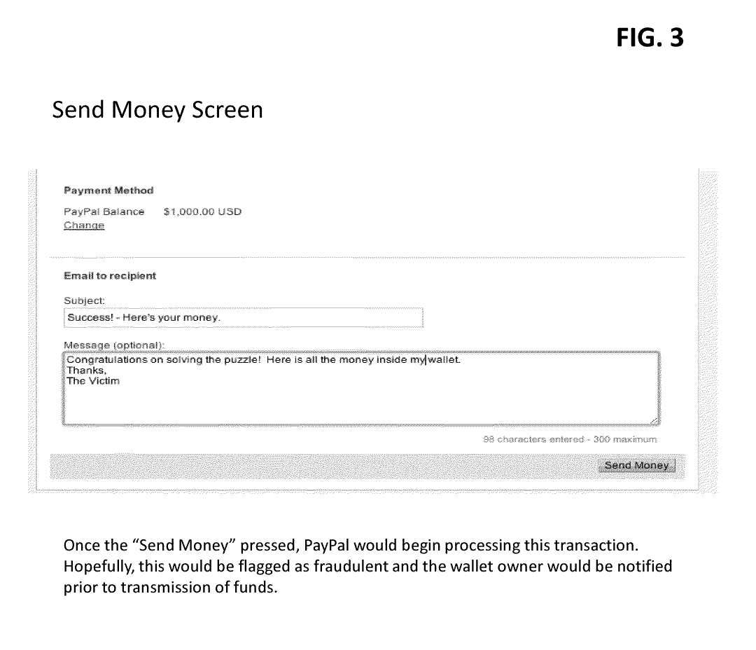

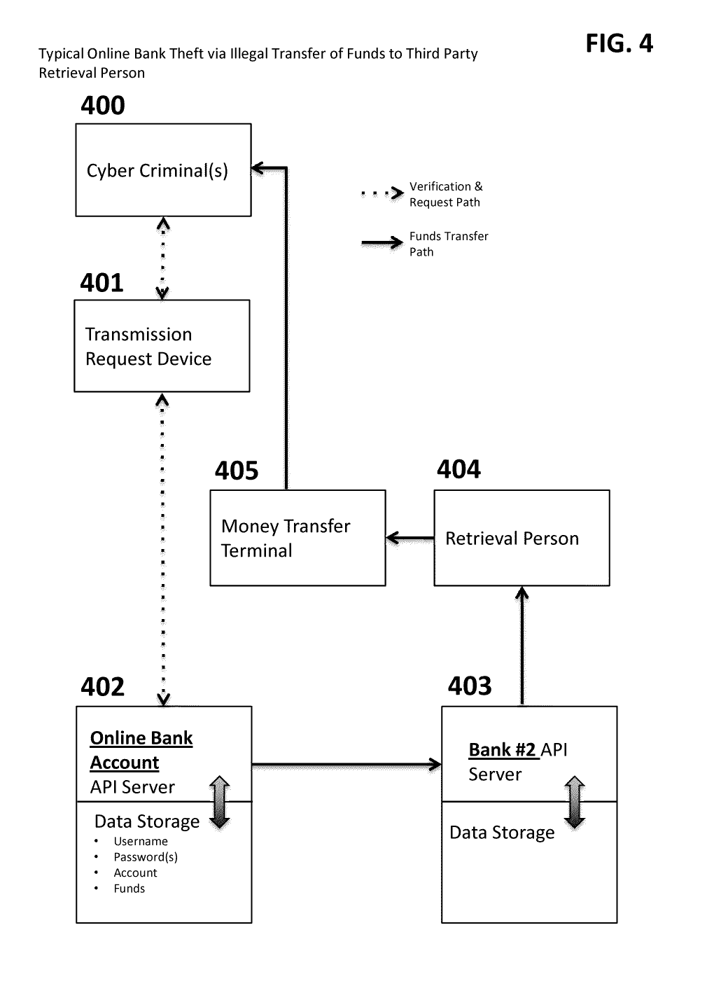

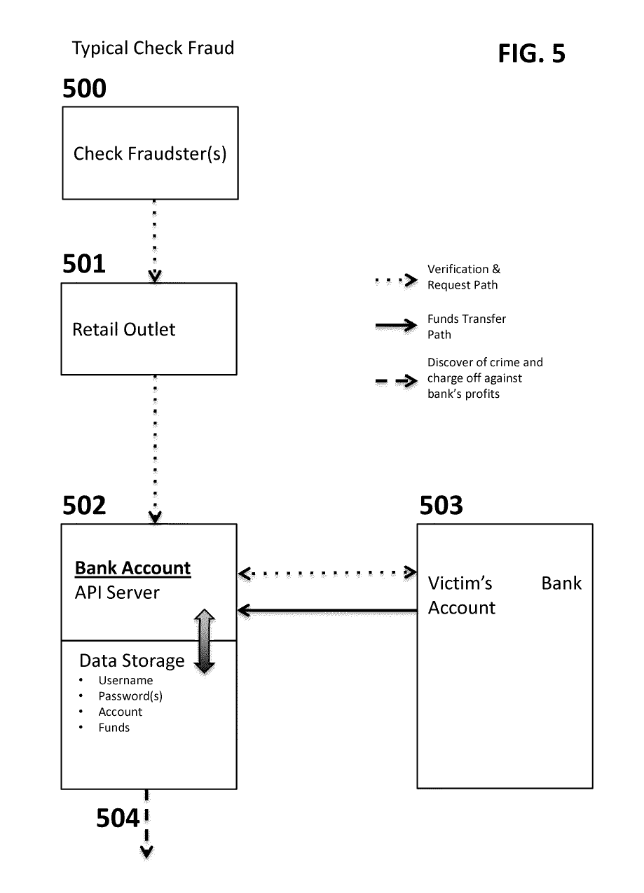

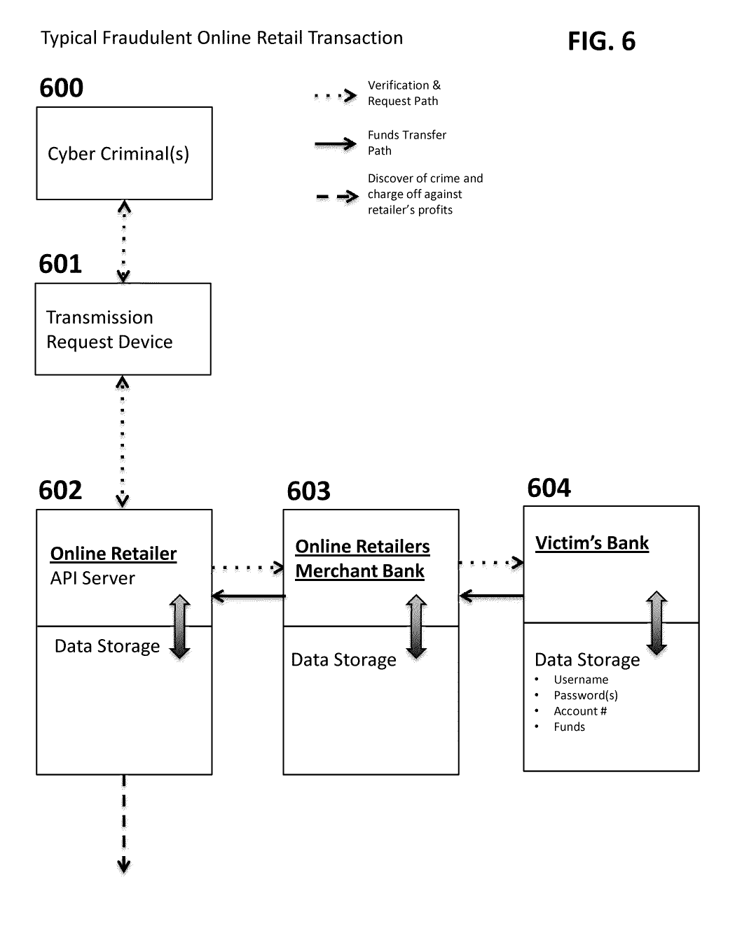

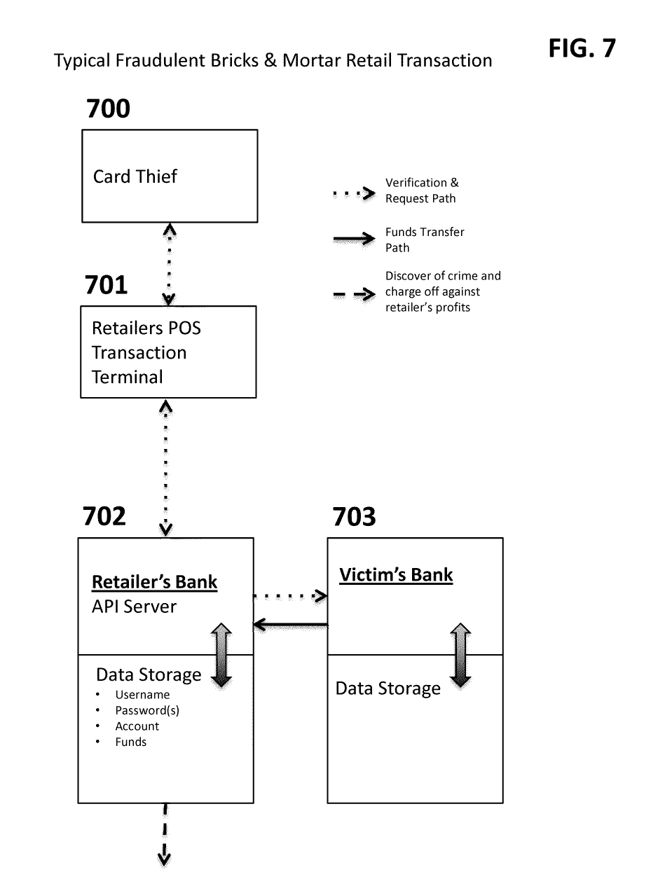

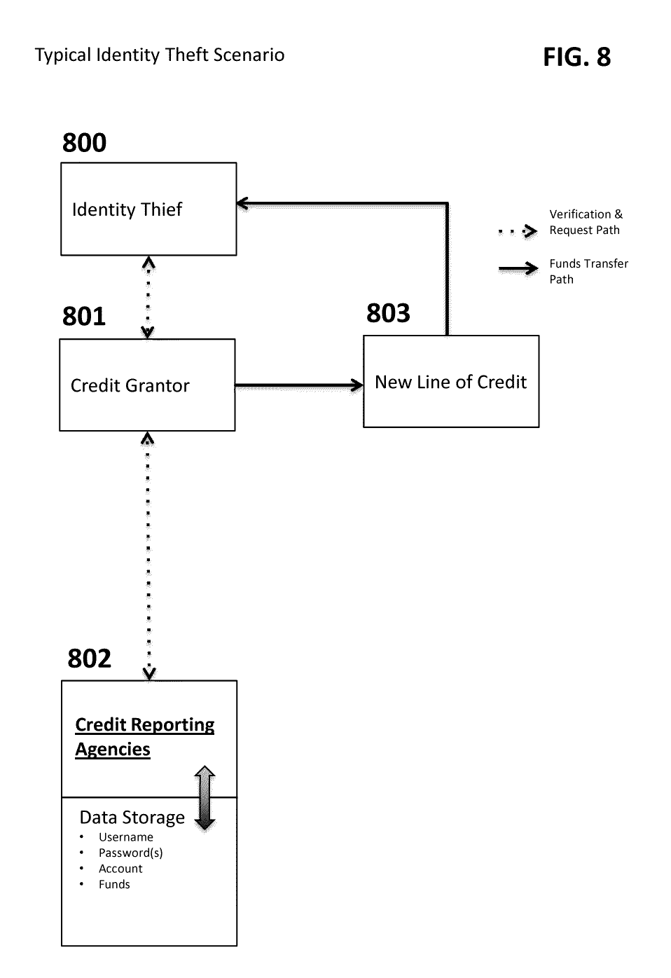

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention, in some embodiments thereof, relates to a method and system for protecting against identity theft in financial transactions and preventing fraud.

Real World Vault

To understand a Virtual Vault, it is helpful to imagine a real vault with a security guard at the entrance. Only the security guard is allowed to enter the vault. Within the vault are numerous lockboxes containing permission cards that permit the taking of action(s) upon information and the access codes required to obtain the permission cards. All persons seeking to take actions must obtain a permission card prior to taking action.

To do so, they must go to the vault, state the action they wish to take, give the guard enough information to locate the lockbox and then supply the guard with the access codes required to obtain a permission card.

Permission cards are one-time use only. Once the individual uses the permission card, they must go back to the vault and obtain another permission card prior to taking a further action.

How to Create a Virtual Vault

The key to creating Virtual Vaults is to “program” this story in the real world. To do this, we need to assign components available in the technology world to the characters and objects within the story.

The vault is the domain name of the server. In other words, what is the server's location? For purposes of illustration, assume the vault is located at www.virtualvaults.com.

The username is the area within the vault containing the lockboxes for the owner of those lockboxes. For example, johnsmith@virtualvaults.comtells the server to look within the johnsmith folder on the server(s) located at www.virtualvaultaults.com.

The security guard is the software operating on the vault server with the permission to retrieve items from the lockboxes and issue permission cards to individuals supplying the correct access codes.

The lockboxes represent the information required to authorize the taking of action on any individual piece of information such as a request for the transfer of funds from a credit card or bank account. The individuals approaching the guard are any party seeking to take action(s) with possession of the information. This includes those individuals authorized to take such action and those individuals who are not authorized.

Definitions

Full Identifying Information is the information required to take action on specific requests. Some examples of Full Identifying Information are ABA and account number for bank accounts and credit card number, expiration date, CVV code and billing address for credit cards.

Unique Identifying Information is only so much of the Full Identifying Information as is required to take action on a specific request. For example, to approve a credit card transaction, the software suggested would not need to know the entire credit card number. The bank name, vault username, payment method type and last four digits of the payment method account number are all that would be required and is therefore is the Unique Identifying Information.

In the analogy, it is the information needed to locate the lockbox within the vault and not the information required to take action.

Access Coded(s) are the specific codes required to unlock information at each security level within the vault.

Request(s) are requests to take specific actions based upon the knowledge of Full or Unique Identifying Information.

In the analogy, these are the requests for permission cards that persons approaching the vault request the security guard to issue.

Requirement(s) are the specific Access Code combinations required to issue Permission(s).

In the analogy, these are the requirements found in the lockbox that the security card must obtain from the requestor prior to issuing a permission card.

Permission(s) are the communication back to requesting party that they are approved to take action upon the request.

In the analogy, these are the permission cards.

Server Domain is the domain at which the Virtual Vault server is hosted.

In the analogy, this is the physical location of the vault?

Vault Username is the uniquely identifying information for the person owning the Virtual Vault.

In the analogy, it is an area within the vault where a specific group of lockboxes is found.

Data Input Software is the software by which personal information, Full Identifying Information and associated Access Code(s) are communicated to the vault server and stored to the server's data storage.

Data Input User is the person utilizing the Data Input Software.

Personal Response Device(s) is any device utilized to input Access Code(s) or other information when prompted by virtual vault server software.

Request Device(s) is any device utilized to input and place Request(s).

Request Confirmation Software is the software running on the virtual vault server which confirms inputs from Personal Response Device(s) and verifies that the inputs match Access Code(s) for Unique Identifying Information stored on virtual vault server prior to issuing Permission(s).

Virtual Vault Server is the API server operating the Input Data Software and Request Confirmation Software and connected to data storage containing the Unique Identifying Information, Access Code(s), Requirement(s) and having the ability to accept Request(s) and issue Permission(s).

Personal Access Vault is the individual file(s) storing the personal information, Unique Identifying Information and Access Code(s) and associated with a specific username and password combination.

Notification Method(s) are the method(s) by which Virtual Vault Server contacts Personal Response Device(s) and requests input of Access Code(s).

Remote Requesting Server is any server placing Request(s).

The following are the components required to create the Virtual Vault.

1. API Server and associated data storage

2. Date Input Software

3. Request Confirmation Software.

4. Personal Response Device

5. Connectivity to a Network

An essential step in securing the functioning of a Virtual Vault is that all Remote Requesting Servers authorized to take action(s) be required to seek Permission(s) from Virtual Vault Servers prior to taking such action(s) on restricted or “locked” information. It is most helpful to conceive of the proper functioning of virtual vaults by utilizing a programming analogy. In object oriented programming, it is relatively easy to program objects that are completely controlled by other objects in regards to performing specific functions. The successful implementation requires various “real world” participants and their servers to coordinate actions as though there were objects within a computer program. In Model View Controller programming conventions, both the virtual vault and the function server are “objects”. The virtual vault server is the controller of the function server in regards to restricted functions much like a character within a video game cannot perform a specific function without input from a user controlled device.

Inititial Setup of New Virtual Vault

To create a new Virtual Vault, a user goes to the vault host's website signup page where the user is directed to choose a username and password.

### For Example:

Username: johnsmith
Password: 1234

The Virtual Vault Server appends the Virtual Vault Server Domain to the username to create the vault name. For example johnmsmith@virtualvaults.com.

The vault username and password are used to input new data into the vault utilizing the Data Input Software only. In other words, unlike current online wallets, the user is not allowed to place Request(s) from within the vault.

The user is then directed to select three access codes.
A Level 1 Access Code (SL1AC)
A Level 2 Access Code (SL2AC)
A Level 3 Access Code (SL3AC)

The above Access Codes should be at least 4 digits long each. No alphanumeric characters are required for security levels to be high as odds of correctly guessing a Security Level 3 access code combination sequence is 10,000×10,000×10,000=1,000,000,000,000.

User is then prompted to enter one or more notification methods and assign priorities to them.

Lastly, user is asked to enter Full Identifying Information for information user wishes to secure within the Virtual Vault and assign security levels to each piece of information.

The software running on Virtual Vault Server, notifies affected party of “locked” status. Waits for notified party to confirm locked status and then stores any information about the notified party necessary to grant Permission(s) and then disposes of any portion of the Full Identifying Information that is non-essential to the creation of the Unique Identifying Information.

Alternatively, the online banking website could be inexpensively reprogrammed to allow for users to click a “lock” icon next to their account numbers. The website would then prompt them to enter their Virtual Vault username. The bank website server would then “push” a request to lock the account to the Virtual Vault Server. The Virtual Vault Server would then send message “Account lock request accepted. Account is now locked.” Bank could then show a “locked” icon to user assuring them of locked status.

In either event, the bank server is now a Remote Requesting Server and is a “slave” to the Virtual Vault Server in regards to this account. It is not allowed to take an action without first obtaining a Permission. In Model View Controller conventions, the Virtual Vault Server is now the controller of the Remote Requesting Server. Again, this is critical to the functioning and security of Virtual Vaults.

Also, central to securing a VIRTUAL VAULT are the following programming rules:

1. Full Identifying Information placed into the vault should be converted into Unique Identifying Information. To accomplish this, the Virtual Vault Server will determine what is essential to creating the Unique Identifying Information and dispose of the non-essential elements of the Full Identifying Information.

2. Data Input User is not allowed to request actions. A VIRTUAL VAULT does not allow for the placing of Request(s) from within the virtual vault.

3. Once vault owners “lock” a piece of information, all Remote Requesting Servers must obtain Permission(s) prior to acting on any Request(s) relating to the locked information.

4. Virtual Vault Server must request input of Access Code(s) by user on a Personal Response Device.

5. Modification of Access Codes and Notification Methods require the following convention:
a. Enter old Access Code(s)/Notification Method(s)
b. Enter new Access Code(s)/Notification Method(s)
c. Re-enter new Access Code(s)/Notification Method(s)

By following these methods, the Virtual Vault is highly secure because the VIRTUAL VAULT contains no actionable information for individual(s) who gain unauthorized access.

Furthermore, any person gaining unauthorized access to the VIRTUAL VAULT would be unable to place Request(s) since the Data Input Software is not enabled to place Request(s) and unable to make changes to Access Code(s) or Notification Method(s) without prior knowledge of the Access Code(s) and Notification Method(s).

Lastly by requiring the user of the Personal Response Device(s) to input the correct Access Code(s) prior to Virtual Vault Server issuing the Permission(s), the user gaining access to a Virtual Vault, Full Identifying Data and Access Code(s) would be unable to grant Permission(s) unless they also were in possession of the Personal Response Device.

In summary, the Virtual Vault is a highly secure method for confirming that Request(s) placed upon Remote Requesting Servers are in fact placed by person(s) authorized to place said requests.

Furthermore, it would render any piece of Full Identifying Information that has been locked with the Personal Identification Vault almost useless to unauthorized person(s) since Remote Requesting Server(s) are required to obtain Permission(s) from the Virtual Vault Server prior to acting upon Request(s).

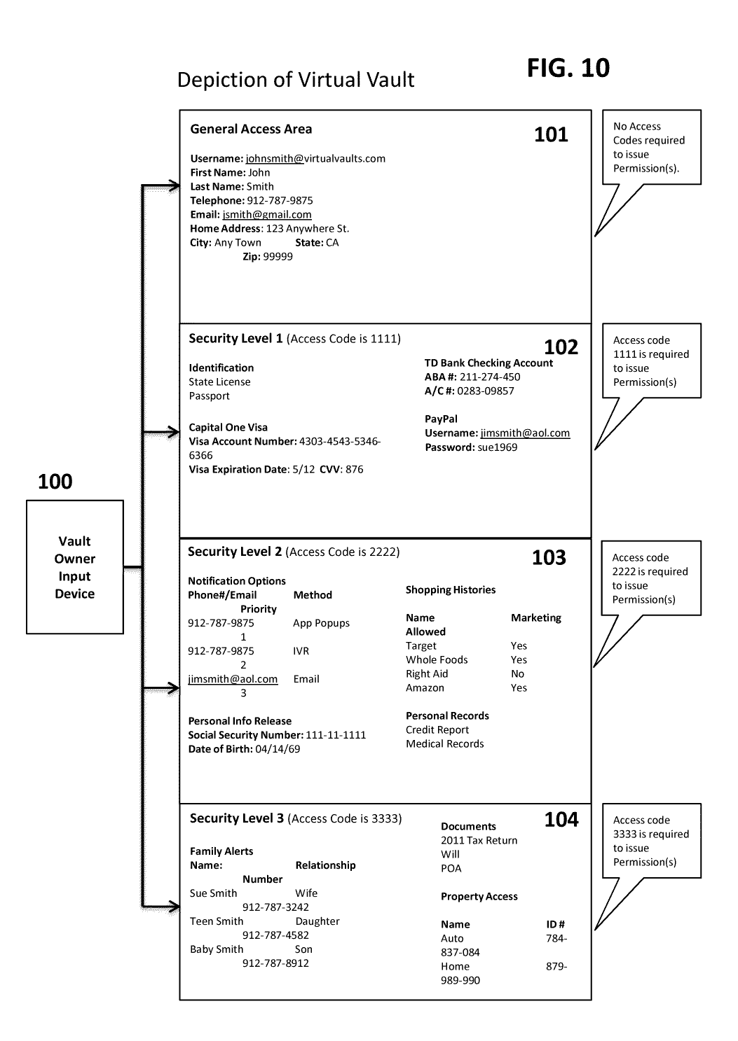

Referring to the drawings, FIG. 10 is a depiction of a Virtual Vault. In a variant, the Virtual Vault comprises a Vault Owner Input Device 100, a General Access Area 101, Security Level 1 Information 102, Security Level 2 Information 103, and Security Level 3 Information 104.

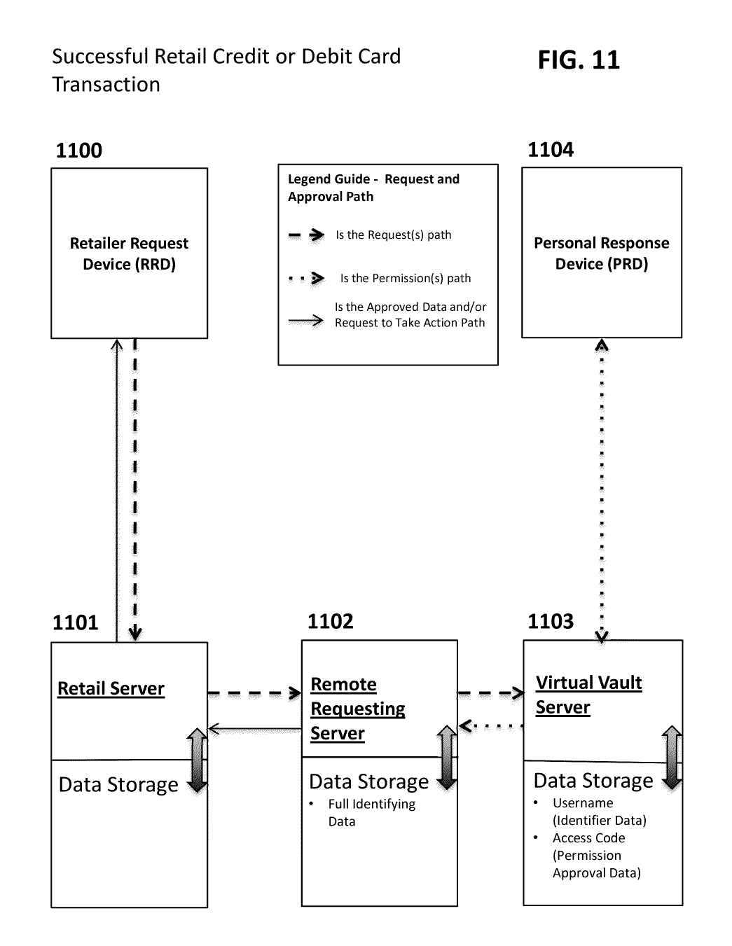

In another variant, referring to FIG. 11, a depiction of a successful retail credit or debit card transaction is illustrated. The successful retail transaction comprises: A Retailer Request Device 1100; a Retailer Server 1101; a Remote Requesting Server (retailer's bank) 1102; a Virtual Vault Server 1103; and a Personal Response Device 1104. A request path, permission path and an approved data and/or request to take action path are provided.

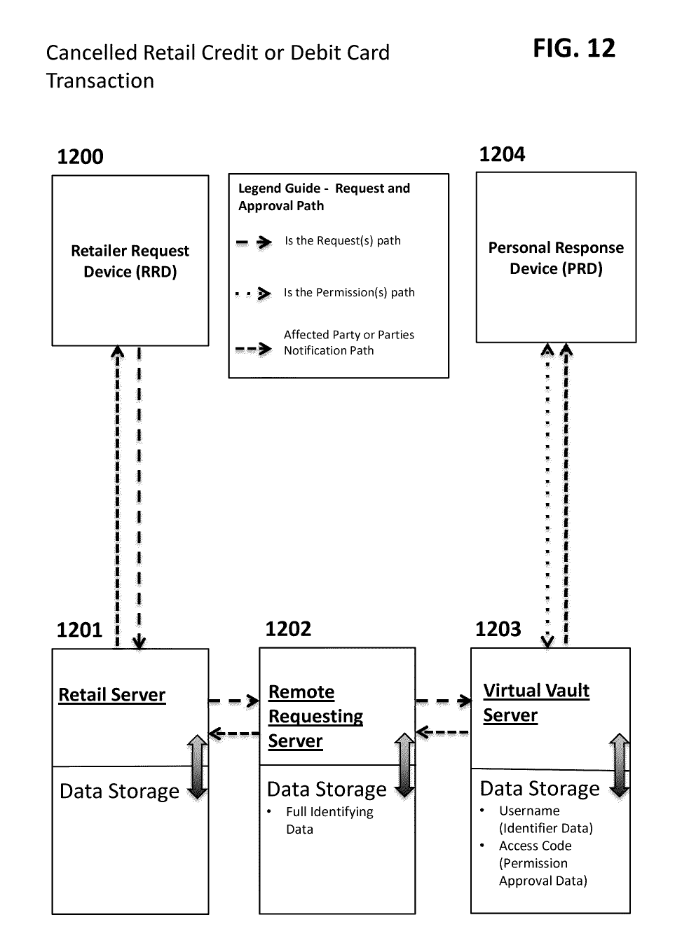

In a further variant, referring to FIG. 12, a cancelled retail credit or debit card transaction is illustrated. A Retailer Request Device 1200, a Retailer Server 1201, a Remote Requesting Server (Retailer's bank) 1202, a Virtual Vault Server 1203 and a Personal Response Device 1204 are provided. A request path, permission path and an affected party notification path are provided.

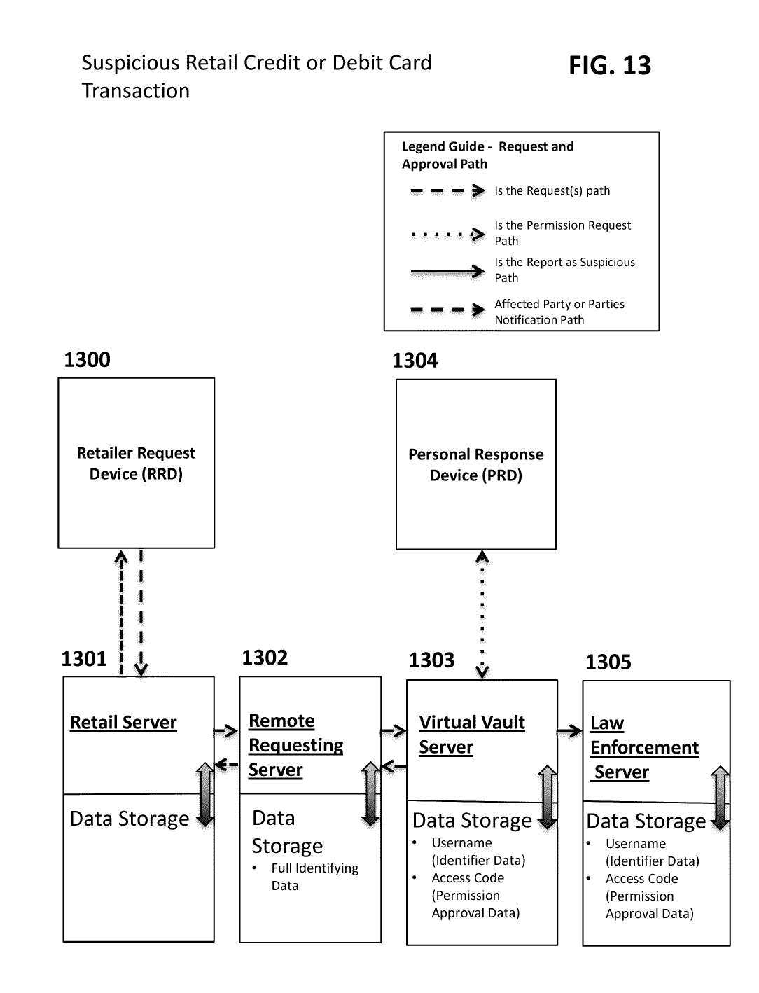

In still another variant, referring to FIG. 13, a reported lost or stolen credit card or debit card transaction is illustrated. A Retailer Request Device 1300, a Retail Server 1301, a Remote Requesting Server 1302, a Virtual Vault Server 1303, a Personal Response Device 1304 and a Law Enforcement Server 1305 are provided. A request path, permission path, a report as suspicious path and an affected party notification path are provided.

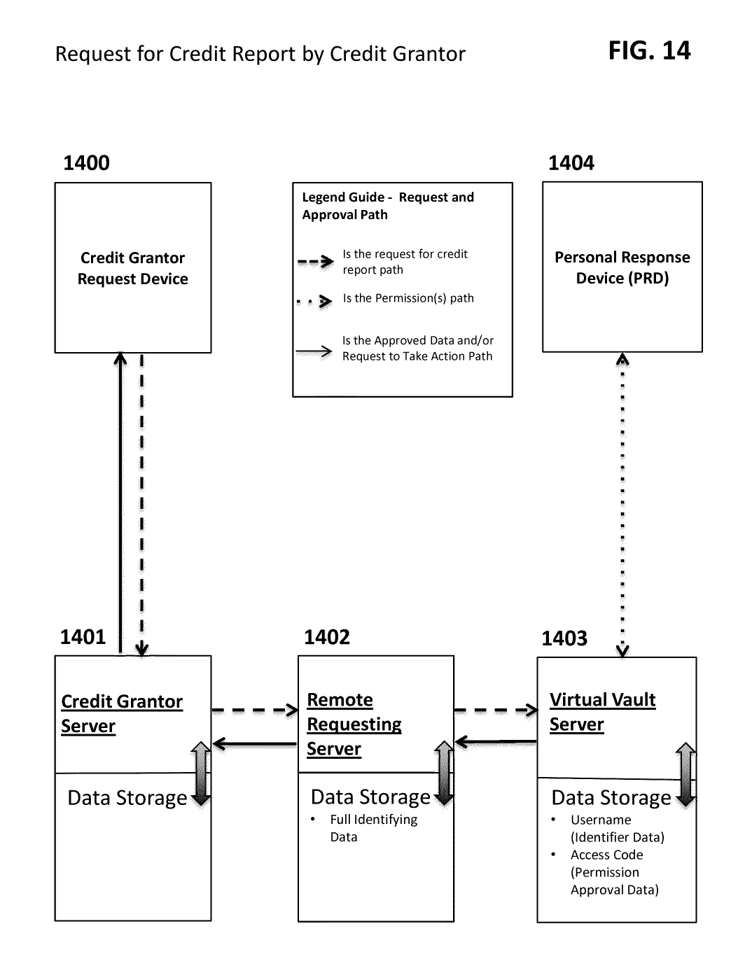

In yet a further variant, referring to FIG. 14, a request for credit report initiated on Credit Grantor Request Device process is illustrated. A Credit Grantor Request Device 1400, a Credit Grantor Server 1401, a Remote Requesting Server (the credit bureaus) 1402, a Virtual Vault Server 1403, and a vault owner Personal Response Device 1404 are provided. A request for credit report path, permission path, and an approved data and/or request to take action path are provided.

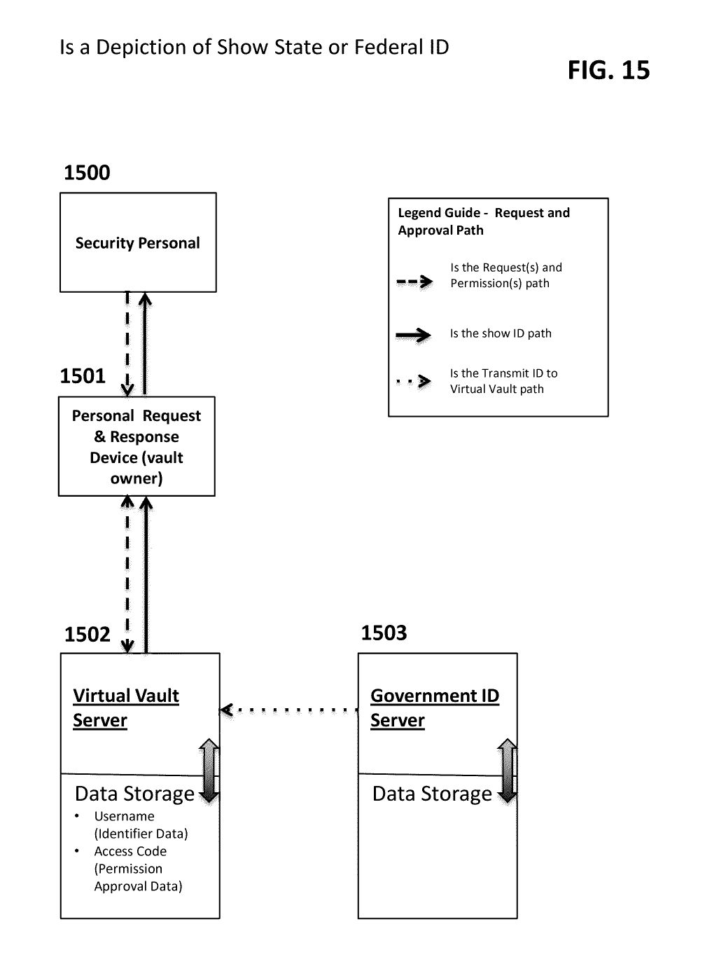

In a variant, referring to FIG. 15, a request to show ID initiated on Personal Request & Response Device process is illustrated. A Security Personal requesting to see ID 1500, a Personal Request & Response Device 1501, a Virtual Vault Server 1502, and a Government ID Server 1503 are provided. A request path, permission path, and a transmit ID to Virtual Vault path are provided.

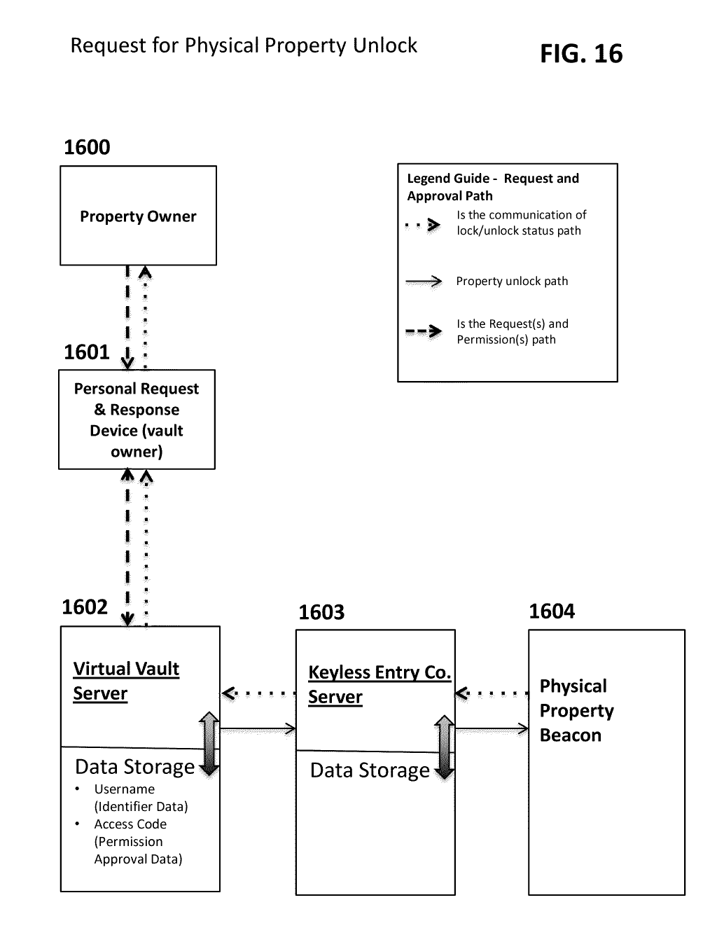

In another variant, referring to FIG. 16, a process for “unlocking” physical property Request(s) on a Personal Request & Response Device is illustrated. A Property Owner 1600, a Personal Request & Response Device 1601, a Virtual Vault Server 1602, a Keyless Entry Co. Server 1603 and a Physical Property Beacon 1604 are provided. A request path, permission path and a property unlock path are provided.

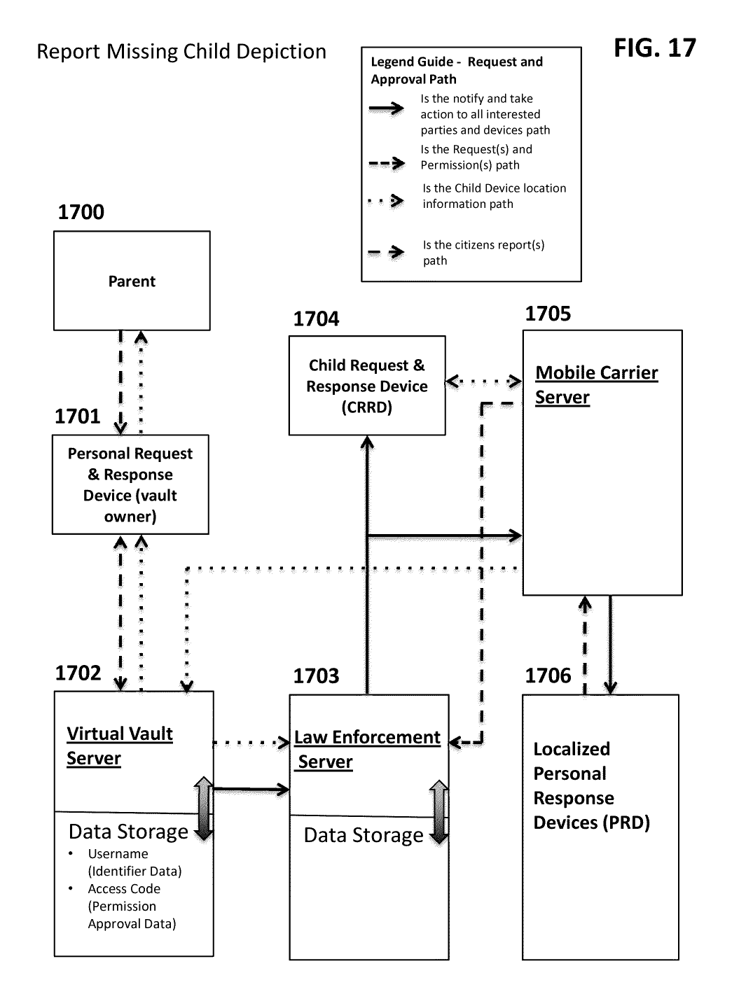

In a further variant, referring to FIG. 17, a Missing Child Report process is illustrated. A Parent 1700, a Parent Request & Response Device 1701, a Virtual Vault Server 1702, a Law Enforcement Server 1703, a Child Request & Response Device 1704, a Mobile Carrier Server 1705, and a Localized Personal Response Device(s) 1706 are provided. A notify and take action to all interested parties and devices path, a request and permissions path, a Child Device location information path, and a citizens report path are provided.

Definitions
RRS is the Requesting Server
VIRTUAL VAULT is the Virtual Vault
PRD is the vault owner's Personal Response Device
PPD is a Personal Property Beacon
CRRD is a Family Child Request & Response Device
RRD is Retailer Request Device or software. This could be either a POS terminal, website or initiated on the vault owner's PRD
MC is mobile carrier
SL1AC is the access cord for security level one

SL2AC is the access cord for security level two

SL13C is the access cord for security level three

Rules for Accessing Information within a Virtual Vault (See FIG. 10)
General Access: Username only
Security Level 1: SL1AC required
Security Level 2: SL1AC and SL2AC required
Security Level 3: SL1AC, SL2AC and SL3AC required.
   The following is an example process:
RRS to VIRTUAL VAULT: What is email address for johnsmith@virtual vault.com?
VIRTUAL VAULT to RRS: johnsmith@gmail.com
RRS to VIRTUAL VAULT: What is phone for johnsmith@virtualvaults.com?
VIRTUAL VAULT to RRS: 912-787-9875

FIG. 11 is a depiction of a credit card transaction initiated by either a card swipe or entry of card number, expiration date and CVV on website. The following is an example process:
Retailer Server to RRS: Amazon requests to charge johnsmith@virtualvaults.com Visa ending in 6366 for $50.
RRS to VIRTUAL VAULT: Amazon requests to charge johnmsmith@virtualvaults.comVisa ending in 6366 for $50.
VIRTUAL VAULT to PRD: Amazon would like to charge your Visa ending in 6266 for $50
PRD to VIRTUAL VAULT: confirm
VIRTUAL VAULT to PRD: please enter SL1AC
PRD to VIRTUAL VAULT: 1111
VIRTUAL VAULT to PRD: please enter SL2AC
PRD to VIRTUAL VAULT: 2222
VIRTUAL VAULT to RRS: Permission granted
VIRTUAL VAULT to PRD: You've granted permission to Amazon to charge $50 to your VISA ending in 6266.

The following is a request for payment from a Retailer wherein VIRTUAL VAULT owner exposes only Vault Username to Retailer and utilizes a Retailer Request Device (RRD). The following is an example process:
RRD to VIRTUAL VAULT: Please show payment method(s) for johnsmith@virtualvaults.com
VIRTUAL VAULT to RRD: Payment methods are:
Visa ending in 6266
Bank AC ending in 9857
PayPal
RRD to VIRTUAL VAULT: Visa
VIRTUAL VAULT to PRD: Amazon would like permission to charge $50 to your Visa ending in 6266. Please enter SL1AC
PRD to VIRTUAL VAULT: 1111
VIRTUAL VAULT to PRD: please enter SL2AC
PRD to VIRTUAL VAULT: 2222
VIRTUAL VAULT to RRS: Permission granted
VIRTUAL VAULT to RRS: You've granted permission to Amazon to charge $50 to your VISA ending in 6266.
RRS to Amazon Server: Please find $50 attached from johnsmith@virtualvaults.com.

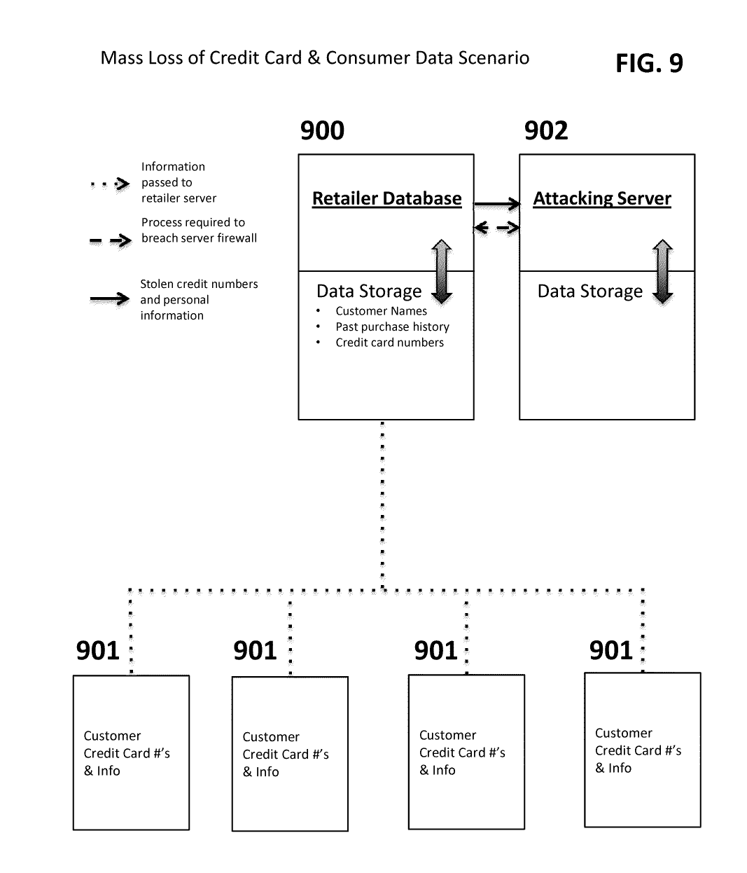

Once implemented, the above method would remove the need for retailers to transmit and store Full Identifying Information for payment methods. This would help to reduce the mount of data losses like the scenario depicted in FIG. 9.

FIG. 13 is a Request for payment from a retailer that is reported as suspicious by the vault owner. The following is an example process:
RRS to VIRTUAL VAULT: Permission to send $50 to Amazon from VISA ending in 6266?
VIRTUAL VAULT to PRD: Amazon would like to charge your Visa ending in 6266 for $50
PRD to VIRTUAL VAULT: suspicious
VIRTUAL VAULT to PRD: Are you sure?
PRD to VIRTUAL VAULT: yes
VIRTUAL VAULT to PRD: please enter SL1AC
PRD to VIRTUAL VAULT: 1111
VIRTUAL VAULT to RRS: Reposted at suspicious.
RRS to VIRTUAL VAULT: Visa has been locked, notify card holder.
VIRTUAL VAULT to PRD: Your Visa ending is 6266 is now locked. Please call 888-558-9998 immediately.

The method once implemented would reduce the need to reissue reported lost or stolen credit cards. Bank account numbers could be reissued and could be obscured from all parties other than issuing bank whereas Unique Identifying Information is all that is needed to place Request(s) for payment method. This would virtually eliminate the risk of Full Identifying Information data loss for information locked in Virtual Vaults.

The following is an example of a request by a bank to clear a paper check.
RRS to VIRTUAL VAULT: Permission to clear check to Target for $50
VIRTUAL VAULT to PRD: TD Bank would like to clear a $50 check payable to Target?
PRD to VIRTUAL VAULT: confirm
VIRTUAL VAULT to PRD: please enter LS21AC
PRD to VIRTUAL VAULT: 1111
PRD to VIRTUAL VAULT: confirm
VIRTUAL VAULT to PRD: please enter SL2AC
PRD to VIRTUAL VAULT: 2222
VIRTUAL VAULT to PRD: Permission granted
VIRTUAL VAULT to RRS: Permission to clear check has been granted. Thank you.

FIG. 14 is a depiction of a request for credit report from third party. The following is an example process:
RRS to VIRTUAL VAULT: Ford Motor Credit requesting credit report for johnsmith@virtualvaults.com
VIRTUAL VAULT to PRD: “Ford Motor Credit would like to access your credit report? Please confirm, cancel or report as suspicious”
PRD to VIRTUAL VAULT: confirm
VIRTUAL VAULT to PRD: what is SL1AC?
PRD to VIRTUAL VAULT: 1111
VIRTUAL VAULT to RRS: Permission granted
VIRTUAL VAULT to PRD: Ford Motor Credit has been given permission to access your credit report.

The following is an example of a request to access a credit report where the request is subsequently reported as suspicious.
RRS to VIRTUAL VAULT: Ford Motor Credit requesting credit report for johnsmith@virtualvaults.com
VIRTUAL VAULT to PRD: Ford Motor Credit would like to access your credit report? Please confirm, cancel or report as suspicious
PRD to VIRTUAL VAULT: suspicious
VIRTUAL VAULT to PRD: Report request from Ford Motor Credit as suspicious. Are you sure?
PRD to VIRTUAL VAULT: yes
VIRTUAL VAULT to PRD: what is SL1AC?
PRD to VIRTUAL VAULT: 1111
VIRTUAL VAULT to RRS: Request denied. Request reported as suspicious.
VIRTUAL VAULT to PRD: Reported as suspicious, your credit reported in now “locked”. Please call 888-878-9878 immediately.

FIG. 15 is a depiction of a request to show ID initiated on Personal Request & Response Device. The following is an example process:
PRD to VIRTUAL VAULT: please show passport
VIRTUAL VAULT to PRD: please enter SL1AC
PRD to VIRTUAL VAULT: 1111
VIRTUAL VAULT to PRD: Please enter SL2AC
PRD to VIRTUAL VAULT: 2222
VIRTUAL VAULT to PRD: Image of passport is pushed to PRD and shown on screen.

A suggested method is to allow only authorized State and/or Federal agencies to “push” ID information into VIRTUAL VAULT. This method once implemented would serve to reduce unauthorized person(s) from gaining access to all types of physical properties.

The security for this method could be further enhanced by the use of VIRTUAL VAULTS by law enforcement and security terminals. For example, a government ID could be pushed directly to a government owned VIRTUAL VAULT like tsa-pwm@virtualvaults.com. Terminals at security entrances could show the requested ID based upon Request(s) from VIRTUAL VAULTS of individuals seeking to gain access or entrance to restricted areas.

Instructions to the VIRTUAL VAULT server by individuals would be something like “Please transmit passport to tsa-pwm@virtualvaults.com”. The VIRTUAL VAULT would confirm the request and then transmit a request to a government server to transmit the requested ID. The tsa-pwm@virtualvaults.com VIRTUAL VAULT would be programmed to only accept ID's from authenticated government ID servers.

FIG. 16 is a depiction of a Property Unlock Request initiated on Personal Request & Response Device. The following is an example process:
PRD to VIRTUAL VAULT: Please unlock property ID 784-837-084
VIRTUAL VAULT to PRD: Unlock automobile. Are you sure?
PRD to VIRTUAL VAULT: yes
VIRTUAL VAULT to PRD: Please enter SL1AC
PRD to VIRTUAL VAULT: 1111
VIRTUAL VAULT to PRD: Please enter SL2AC
PRD to VIRTUAL VAULT: 2222
VIRTUAL VAULT to PRD: Please enter SL3AC
PRD to VIRTUAL VAULT: 3333
VIRTUAL VAULT to PPB: Function: unlock
VIRTUAL VAULT to PRD: Your auto has been unlocked. Thank you.

FIG. 17 is a depiction of a report missing person request initiated on a Personal Request & Response Device. The following is an example process:
PRD to VIRTUAL VAULT: Please report Teen Smith as missing
VIRTUAL VAULT to PRD: Report Teen Smith as missing? Are you sure?
PRD to VIRTUAL VAULT: yes
VIRTUAL VAULT to PRD: Please enter SL1AC
PRD to VIRTUAL VAULT: 1111
VIRTUAL VAULT to PRD: Please enter SL2AC
PRD to VIRTUAL VAULT: 2222
VIRTUAL VAULT to PRD: Please enter SL3AC
PRD to VIRTUAL VAULT: 3333
VIRTUAL VAULT to PRD: Your teen has been reported as missing. Law enforcement authorities have been notified and we have locked the Virtual Vault for Teen Smith. Request to obtain Teen Smith's device location has been transmitted to Mobile Carrier and will be reported to you and the appropriate authorities upon receipt. Please call National Missing Person's hotline at 888-888-8888 immediately!
VIRTUAL VAULT to CRRD:
Function: Sound Alarm (very, very loud)
Show Message: Teen Smith has been reported to law enforcement authorities as missing. Teen Smith's Virtual Vault has been locked and is not accessible from this device.
VIRTUAL VAULT to MC: Notify all PRD's within an X radius.
MC to localized PRD: 911 Alert. Teen missing. Please check location on device and listen for panic alarm. Please report findings utilizing this report window:
Location:
Time:
Details:
Report details are sent to Law Enforcement for immediate action.
Tax Return Request Example

The following is an example of a vault owner initiated document request:
PRD to VIRTUAL VAULT: Please send Tax Return 2011 to loanofficer@virtualvaults.com
VIRTUAL VAULT to PRD: Send tax return to your loan officer's vault at loanofficer@virtualvaults.com?
PRD to VIRTUAL VAULT: yes
VIRTUAL VAULT to PRD: Please enter SL1AC
PRD to VIRTUAL VAULT: 1111
VIRTUAL VAULT to PRD: Please enter SL2AC
PRD to VIRTUAL VAULT: 2222
VIRTUAL VAULT to PRD: Please enter SL3AC
PRD to VIRTUAL VAULT: 3333
VIRTUAL VAULT would now copy the tax return to the loan officer's vault for download by the loan officer. The document would be auto purged from the loan officer's vault in a specified time period. This would be set by the vault owner “Purge all tax returns sent after X days”

Suggestive Selling Example

The following is an example of turning on suggestive marketing based upon personal shopping history for a given retailer. The suggested method is to allow a vault owner to opt in to permission-based marketing. The retailer would then be allowed to deliver marketing messages to the virtual vault for access by the vault owner.

The vault owner would however be able to opt out from receiving any further messages by indicating their wishes within the virtual vault. At this point, the virtual vault would notify the retailer and disallow further messages from being delivered to the virtual vault by that retailer.

Suggested marketing examples include, coupons, sales, specials, promotions and events to be delivered to Virtual Vault for later recall utilizing mobile app and/or websites. The following is an example process:
PRD to VIRTUAL VAULT: Please turn on marketing for Whole Foods
VIRTUAL VAULT to PRD: Turn on marketing for Whole Foods. Are you sure?
PRD to VIRTUAL VAULT: yes
VIRTUAL VAULT to PRD: Please enter SL1AC
PRD to VIRTUAL VAULT: 1111
VIRTUAL VAULT to PRD: Marketing for Whole Foods is now turned on. Please check Whole Foods folder on App for available coupons.

Sample Credit Card Transaction

The following is an example credit card transaction in accordance with the principles of the invention.

Definitions

Full Identifying Data

Card Holder Name: John Smith

Bank Name: Capital One

Card Type: Visa

Card Number: 4545-3454-3453-4788*
Expiration Date May 1, 2014
CVV Code: 555*
Billing Address: One City Center, 11th Fl. Portland, Me. 04101*
Vault Username: johnsmith@virtualvaults.com
*Indicates data that should never be store on virtual vault server's memory.

Unique Identifying Data (stored in Virtual Vault)
Vault Username: johnsmith@virtualvaults.com
Bank Name: Capital One
Payment Type: Visa
Last four digits of card number: 4788
Level 1 access Code: 4545

Notification Methods

These are the method by which the user has chosen to be notified of charges to their Capital One Visa:
1. Text confirm to 207-807-8238
2. Voice Response to 207-807-8238 (used only if the user does not reply via text within a specified period of time). The user might not be in an area with data coverage so this backup method would be useful.

Initial Implementation

This implementation does not require a rewrite of existing processes for online shopping carts or physical point of sale terminals. It would be the easiest to implement since it requires only that the bank coordinate with the virtual vault company.

The following is an example process:

1. The user goes to a retail outlet and swipes his credit card. For the purposes of this illustration, the retail outlet is Target.

2. The Point of Sale (POS) machine at Target sends a message to the Target Servers with instructions to collect funds from the user's Capital One Visa.

3. The Target server transmits the user's Full Identifying Data to Target's Merchant Bank. The merchant bank is the company contracted by Target to process credit card transactions.

4. The Merchant Bank transmits the Full Identifying Data to Capital One for authorization.

5. Capital One verifies that the user's card number, expiration date and CVV code match what's stored in their servers and checks that the user has the available funds.

6. Because Capital One has agreed to work with a Virtual Vault company, they also have the user's vault username stored with the user's card data and have flagged the user's Visa as being “locked” in a virtual vault, meaning that they have an agreement with the user that they will seek permission from the user's virtual vault prior to authorizing transactions.

7. Capital One transmits a request to the virtual vault server for permission to allow Target to charge $50 to Visa ending in 4788 belonging to vault username johnsmith@virtualvaults.com. To do this, they only need to transmit the following:
a. Merchant Name
b. Charge Amount
c. Vault Username
d. Payment Method
e. Bank Identification Number and/or Name
f. Last four digits of card number.

8. The virtual vault server receives the message. It contains everything required to authorize the transaction. The Virtual Vault has one task. To notify the vault owner and seek a response; accept, decline, report as fraudulent and report the response back to Capital One.

9. The virtual vault then transmits a request for authorization to the vault owner using the notification method specified by the user for this payment method. The message sent to the user would read something like, for example, “Target is requesting to charge $50 to your Capital One Visa ending in 4788. Please text back your access code to confirm, 5555 to decline or 9999 to report as fraudulent.”

10. The user receives the text message and text back 4545

11. The virtual vault receives a text message from 207-807-8238 with the access code 4545. It confirms that this matches the user's Level 1 access and it further confirms that the text message originated from the preselected notification method 207-807-8238

12. Once confirmed, the virtual vault sends a permission to Capital One to transmit the funds to Target's merchant bank. The process then continues to proceed along the normal channels from this point on.

The reason this method is inferior to the following method is that the user's full visa #, expiration date, CVV, etc. has been transmitted across multiple servers and a number of parties who have no reason to be in possession of the full data other than to authorize the transaction. Furthermore, the data is often stored on a retailers and merchant banks servers. It may also be stored in written format depending on the size of the retailer. The ideal embodiment would eliminate the need to transmit and store this data altogether and would work as follows:

1. The user goes into Target and enter the user's vault username on a point of sale terminal johnsmith@virtualvaults.com

2. Target's POS terminal transmits a message to the virtual vault server that says “Target would like to charge $50, please show payment methods”

3. The user's virtual vault sends a message to the user's phone prompting the user for the user's vault password

4. The user enters it and transmits the code back

5. The user's virtual vault confirms that the code the user entered matches the code for the user's virtual vault and then transmits a message to the user's smart phone “show payment methods”

6. The smart phone app opens and displays a screen showing:
Capital One Visa ending in 4788
Mastercard ending in 4544
American express ending in 3433

7. The user would then select a payment method and push send.

8. The user's virtual vault receives the message and then prompts the user for the Level 1 Access Code

9. The user enters 4545 and pushes send.

10. The user's Virtual Vault confirms that the code the user entered matches the user's Level 1 Access Code and transmits a message to Capital One “Please send $50 to Target for vault username johnsmith@virtualvauts.com Visa ending in 4788”

11. Capital One transmit a message to Target's Server's “$50 from virtual vault johnsmith@virtualvaults.com”

12. Target server transmits a message to the POS terminal “$50 received for johnsmith@virtualvualts.com”. The clerk acknowledges the user's payment and the user leaves the store with the merchandise.

The advantage of this method is that the Full Identifying Data is never transmitted or stored on third-party servers. It therefore eliminates the risk of Target losing the user's card data to hackers since they do not have the data. The only thing they have stored on their servers is the user's vault username. The vault username is almost useless information. It is similar to knowing someone's email address. This would even allow for the removal of the full card number from the physical Visa card. Printed on the card would simply be the vault username, the Visa symbol, the bank name and the last four digits on the account number.

The reason an email address format is chosen in the above example is that it relies on existing convention. With an email address one knows the location of the vault on the vault server (works just like an email in box). The virtualvaults.com tells any computer in the world where to find the vault on the internet.

johnsmith@me.com tells an email server, send this message to the mailbox named “johnsmith” and me.com tells any email server that the mailbox is hosted at me.com

johnsmith@virtualvaults.com tells any transaction server, send the permission request to the server hosted at virtualvaults.com to the vault name of johnsmith.

Note that Target cannot even request unique identifying data for the payment methods since the prompt to transmit the user's payment methods was sent to the phone and was never entered on Target's POS Terminal. Target does not even know what payment method the user used. The only information they receive is $50 received from johnsmith@virtualvault.com

The method can be used for virtually any type of transmission request including request for medical records, requests for credit reports, request to report a missing person, request to transmit a tax return to a bank for approval of a business credit line, etc.

Sample Lock and Unlock Requests

Below is a process on how account would be locked and unlocked.

Example of Locking a Bank Account #1

1. The user logs into the user's virtual vault and enters the full 16 digit card number of the card the user would like to lock.

2. The user's virtual vault transmits a message to Capital One, please lock Visa ending in 4788 and belonging to vault johnsmith@virtualvaults.com

3. Capital One transmits back a request to the user's virtual vault. “Lock request accepted, Visa is now locked”

4. Whenever the user logs into the user's Capital One account, the user would see a small lock indicating locked status.

5. Capital One is now required to obtain permission from the user's virtual vault before transmitting funds.

Example of Locking a Bank Account #2

1. The user logs into the user's Capital One account and clicks the lock icon

2. Capital transmits a message to the user's virtual vault. “Requesting lock status for Visa ending in 4788 belonging to vault johnsmith@virtualvaults.com

3. The user's virtual vault transmits back a message to Capital One—“Lock request accepted”

4. Capital One now shows a locked icon next to this account.

5. Capital One will now seek permission from the user's vault prior to transmitting funds.

Example of Unlocking a Bank Account #1

1. The user logs into the user's Capital One account and clicks the lock icon to indicate an unlock request.

2. Capital One transmits a message to the user's virtual vault “Request to unlock Visa ending in 4788 belonging to johnsmith@virtualvualt.com”

3. The user's virtual vault transmits a message to the user's phone “Request to unlock Capital One Visa ending 4788, please enter level 1 access code to confirm”

4. The user enters the user's access code and presses send.

5. The user's virtual vault confirms that the code entered matches what it has stored as the user's access code and transmits a message to Capital One “OK to unlock Visa ending in 4788 for johnsmith@virtualvault.com.

6. Capital One transmits back a message to the user's virtual vault. Visa ending in 4788 is now unlocked.

7. The user's virtual vault transmits a message to the user's phone “Capital One Visa ending in 4788 is now unlocked”

8. Capital One is no longer required to seek permission from the user's vault prior to transmitting funds.

The virtual vault has to be injected into the unlock process to prevent someone from obtaining a user's Capital One login information and unlocking the account without the user's knowledge. The user might need to unlock the user's Visa if the user knew the user would be in an area where the user did not have cell phone coverage.

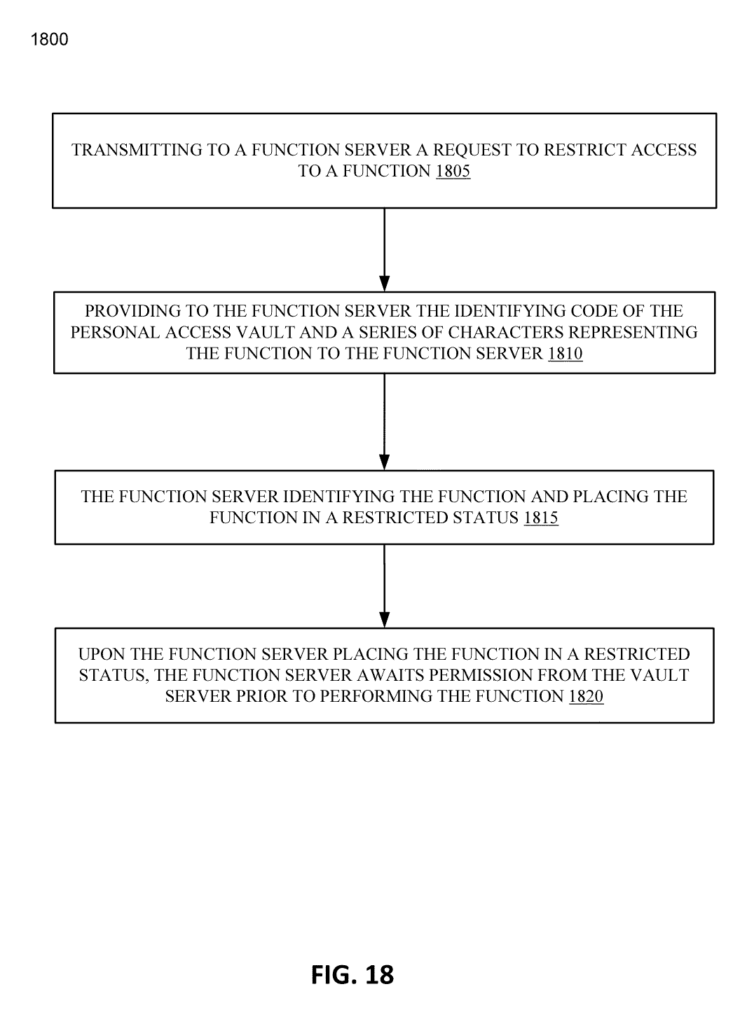

The network comprises at least one function server and a vault server, each having a processor and a memory. The vault server has stored within its memory a personal access vault. The personal access vault comprises at least an identifying code and at least one authorization code. In a variant, referring to FIG. 18, the method 1800 comprises: transmitting to a function server a request to restrict access to a function 1805; providing to the function server the identifying code of the personal access vault and a series of characters representing the function to the function server 1810; and the function server identifying the function and placing the function in a restricted status 1815; upon the function server placing the function in a restricted status, the function server awaits permission from the vault server prior to performing the function 1820.

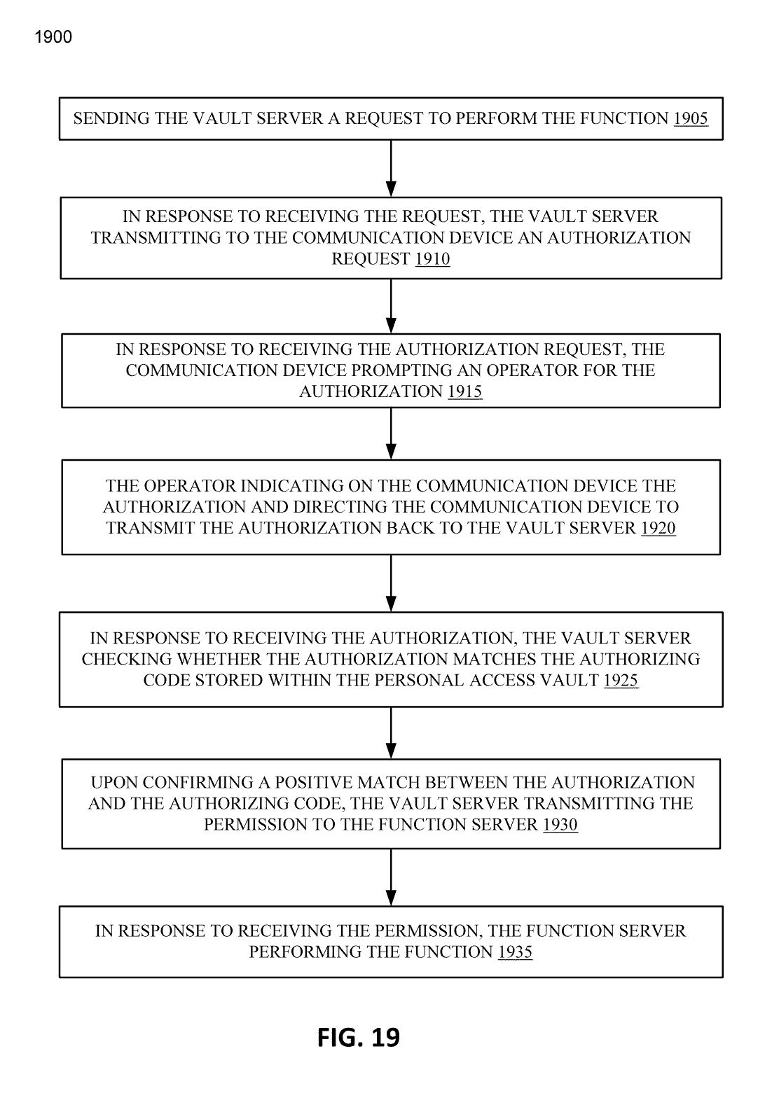

In another variant, referring to FIG. 19, the method 1900 comprises: sending the vault server a request to perform the function 1905; in response to receiving the request, the vault server transmitting to the communication device an authorization request 1910; in response to receiving the authorization request, the communication device prompting an operator for the authorization 1915; the operator indicating on the communication device the authorization and directing the communication device to transmit the authorization back to the vault server 1920; in response to receiving the authorization, the vault server checking whether the authorization matches the authorizing code stored within the personal access vault 1925; upon confirming a positive match between the authorization and the authorizing code, the vault server transmitting the permission to the function server 1930; in response to receiving the permission, the function server performing the function 1935. The vault server does not have the data or the authorization required to perform the function and the function server is not authorized to perform the function without first obtaining the permission from the vault server.

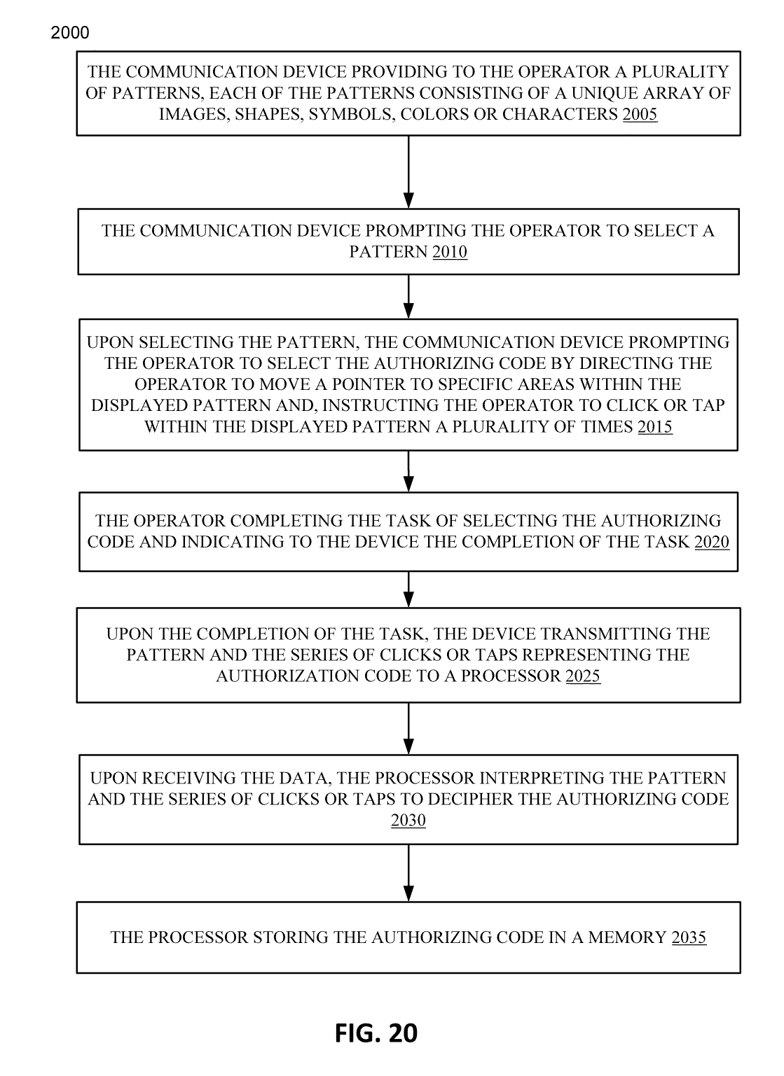

In a further variant, referring to FIG. 20, the method 2000 comprises: the communication device providing to the operator a plurality of patterns, each of the patterns consisting of a unique array of images, shapes, symbols, colors or characters 2005; the communication device prompting the operator to select a pattern 2010; upon selecting the pattern, the communication device prompting the operator to select the authorizing code by directing the operator to move a pointer to specific areas within the displayed pattern and, instructing the operator to click or tap within the displayed pattern a plurality of times 2015; the operator completing the task of selecting the authorizing code and indicating to the device the completion of the task 2020; upon the completion of the task, the device transmitting the pattern and the series of clicks or taps representing the authorization code to a processor 2025; upon receiving the data, the processor interpreting the pattern and the series of clicks or taps to decipher the authorizing code 2030; and the processor storing the authorizing code in a memory 2035.

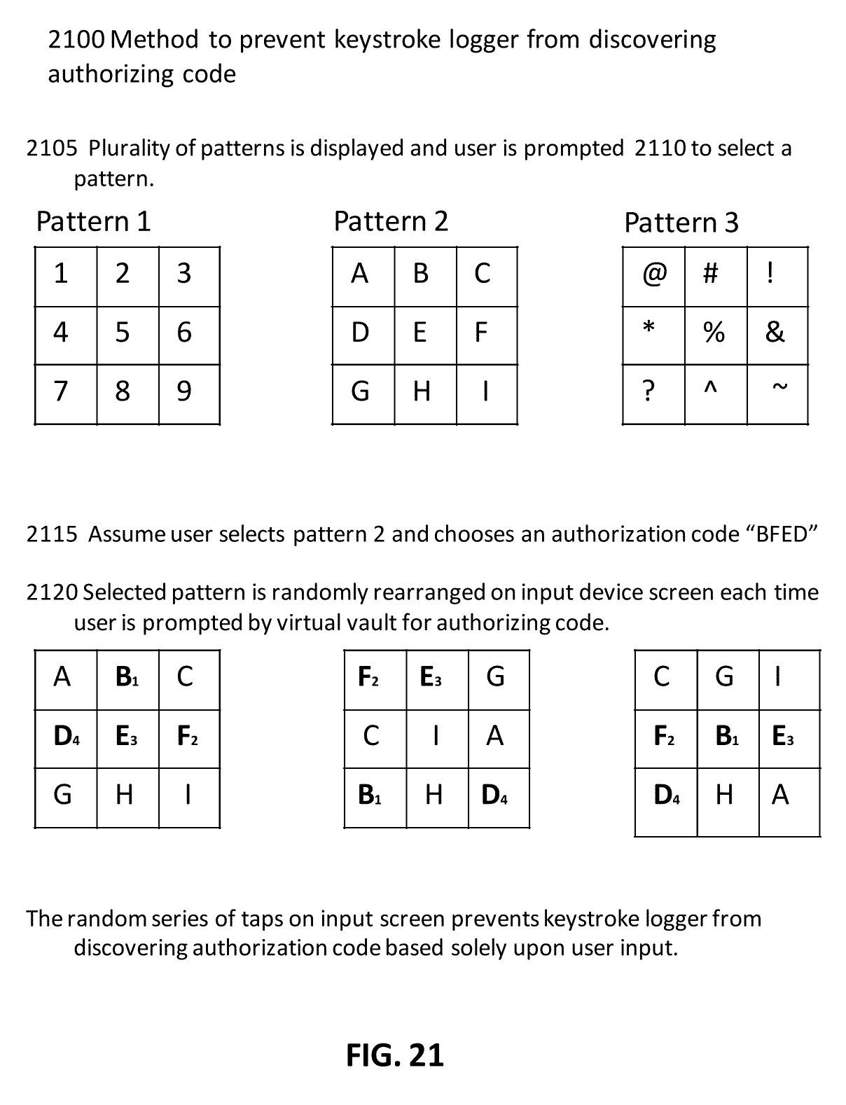

In another variant, referring to FIG. 21, a method 2100 for preventing a keystroke logger from discovering authorizing code, comprises displaying 2105 a plurality of patterns and prompting 2110 the user to select a pattern. If, for example, the user selects 2115 pattern 2 and the user's previously chosen authorization code is “BFED,” the selected pattern is randomly rearranged 2120 on the input device screen each time the user is prompted by the virtual vault for the authorizing code. The random series of taps on the input screen prevents the keystroke logger from discovering the authorization code based solely upon user input.

While various embodiments of the present invention have been described above, it should be understood that they have been presented by way of example only, and not of limitation Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method of restricting access to perform a function over a network, the network comprising at least one function server and a vault server, each having a processor and a memory, the vault server having stored within its memory a personal access vault, the personal access vault comprising at least an identifying code and at least one authorization code, the method comprising:
transmitting to a function server a request to restrict access to a function;
providing to the function server the identifying code of the personal access vault and a series of characters representing the function to the function server;
the function server identifying the function and placing the function in a restricted status;
upon the function server placing the function in a restricted status, the function server awaiting a permission from the vault server prior to performing the function.

2. A method of granting a permission to perform a function over a network, comprising at least one vault server and at least one function server, each having a processor and a memory, the vault server having stored within its memory at least one personal access vault, the network further comprising at least one communication device, the method comprising:
sending the vault server a request to perform the function;
in response to receiving the request, the vault server transmitting to the communication device an authorization request;
in response to receiving the authorization request, the communication device prompting an operator for the authorization;
the operator indicating on the communication device the authorization and directing the communication device to transmit the authorization back to the vault server;
in response to receiving the authorization, the vault server checking whether the authorization matches the authorizing code stored within the personal access vault;
upon confirming a positive match between the authorization and the authorizing code, the vault server transmitting the permission to the function server;
in response to receiving the permission, the function server performing the function;
wherein the vault server does not have the data or the authorization required to perform the function and the function server is not authorized to perform the function without first obtaining the permission from the vault server.

3. The method of granting a permission to perform a function of claim 2, wherein the method further comprises a method of indicating an authorizing code on a communication device, wherein malicious software, such as a keystroke logger, cannot readily determine the substance of the authorizing code, the method further comprising:
the communication device providing to the operator a plurality of patterns, each of the patterns consisting of a unique array of images, shapes, symbols, colors or characters;
the communication device prompting the operator to select a pattern;
upon selecting the pattern, the communication device prompting the operator to select the authorizing code by directing the operator to move a pointer to specific areas within the displayed pattern and, instructing the operator to click or tap within the displayed pattern a plurality of times;
the operator completing the task of selecting the authorizing code and indicating to the device the completion of the task;
upon the completion of the task, the device transmitting the pattern and the series of clicks or taps representing the authorization code to a processor;
upon receiving the data, the processor interpreting the pattern and the series of clicks or taps to decipher the authorizing code; and
the processor storing the authorizing code in a memory.

4. The method of indicating an authorizing code on a communication device of claim 3, further comprising:
the communication device rearranging in a random manner the array of images, shapes, symbols, colors or characters within a pattern each time an operator is prompted to enter the authorizing code;
wherein a malicious software having discovered the unique pattern would further have to determine the random arrangement of the images, shapes, symbols, colors or characters within the pattern in order to decipher the input activity on the communication device and gain knowledge of the authorizing code.

5. The method of granting a permission to perform a function of claim 2, wherein the identifying code of a personal access vault is an internet address, email address or telephone number;
the identifying code providing the information required to determine the location of a vault server and the location of a personal access vault within the memory of a vault server;
wherein the location of a vault server is determined utilizing standard internet and telephony protocols.

6. The method of granting a permission to perform a function of claim 2, further comprising:
in response to the receiving the request, the vault server transmitting to a communication device an authorization request via a predetermined communication channel.

7. The method of granting a permission to perform a function of claim 2, wherein the function server comprises a payment remittance server, and wherein the step of sending the vault server a request to perform the function, comprises:
transmitting to the payment remittance server a request to process a payment;
upon receiving the request, the payment remittance server checking a payment method account number to determine whether the account is in a restricted status;
if the account is in a restricted status, the payment remittance server sending a request to the vault server to grant a permission to process the payment.

8. The method of claim 7 wherein the step of transmitting to a payment remittance server a request to process a payment, further comprises:
the vault server sending to a communication device a list of available payment methods and prompting the operator to select a payment method;
the device displaying each payment method in an abbreviated format to prevent from displaying the full identity of each payment method;
the operator selecting a payment method and transmitting a selection back to the vault server;
upon the vault server receiving the payment method selection, the vault server using the payment method selection to determine the location of a payment remittance server;
the vault server transmitting to the payment remittance server a request to process the payment;
wherein none of the steps in the method contain the payment method account numbers transmitted to or from the communication device and the communication device does not provide to the device operator any of the complete payment method account numbers.

9. The method of claim 7, wherein the step of transmitting to a payment remittance server a request to process a payment, further comprises:
either a payee or a payer transmitting the request to process the payment to either a payment remittance server or a vault server.

10. The method of claim 9, wherein the step of either a payee or a payer transmitting the request to the payment remittance server, further comprises:
providing to a payee an identification code to a personal access vault, the identification code allowing the payee to determine the location of a vault server;
the payee sending to the vault server, the identification code and a request to process a payment;
the vault server using the identification code to determine the location of the personal access vault within the vault server memory;
the vault server performing a plurality of functions to obtain an authorization, a preferred payment method and the location of a payment remittance server;
the vault server transmitting to the payment remittance server a request to process the payment;
wherein none of the steps in the method comprise the payment method account numbers being transmitted and the vault server is not required to have the payment method account numbers to process and transmit the payment request.

11. The method of claim 10, wherein the step of the vault server performing a plurality of functions to obtain an authorization, a preferred payment method and the location of a payment remittance server, further comprises:
the vault server checking whether a preferred payment method is indicated within the personal access vault;
if a preferred payment method is indicated, the vault server transmitting a request for payment to a payment remittance server;
if the preferred payment method is not indicated, the vault server transmitting a request for a selection of payment method to a communication device along with a request for an authorization;
the communication device prompting an operator to select a payment method and provide the authorization;
the operator selecting the payment method and providing the authorization;
wherein none of the steps in the method comprise the payment method account numbers transmitted to or from the communication device or to and from the payee.

12. The method of claim 11, wherein the step of either a payee or a payer transmitting a request to process payment to a payment remittance server, further comprises:
providing to a payer a transaction code;
the payer transmitting to a vault server the transaction code and an identification code of a personal access vault;
the vault server utilizing the identification code to locate a personal access vault within the memory of the vault server;
the vault server performing a plurality of functions to obtain an authorization, a preferred payment method, and the location of a payment remittance server;
the vault server transmitting to the payment remittance server a request for payment in combination with the transaction code;
wherein none of the steps in the method comprise the payment method account number being provided to the payee.

13. The method of claim 12, wherein the step of the vault server transmitting to the payment remittance server a request for payment, further comprises:
upon the payment remittance server receiving a request for payment in combination with the transaction code, the payment remittance server utilizing the transaction code to determine the amount of a payment and the location of a payment acceptance server; and
the payment remittance server sending the payment and the transaction code to a payment acceptance server.

14. The method of claim 13, wherein the step of the payment remittance server sending the payment and the transaction code to a payment acceptance server, further comprises:
upon the payment acceptance server receiving the payment and the transaction code, the payment acceptance server utilizing the transaction code to determine the location of a financial account and a financial account number; and
the payment acceptance server applying the payment to a financial account number.

15. The method of claim 14, wherein the step of the payment acceptance server applying the payment to a financial account number, further comprises:
the payment acceptance server transmitting to payee a confirmation of the payment received along with the transaction code;
the payee utilizing the transaction code to match the payment received to a transaction in process;
in response to receiving the confirmation of payment and the transaction code, the payee matching the transaction code to a transaction in process and allowing the transaction to proceed;
wherein none of the steps comprise: the identity of the payer, the payment method, or the payment method account number being transmitted to or from the payee.

16. The method of claim 12, wherein the step of a payee providing to a payer a transaction code comprises:
providing a transaction code to a communication device;
upon receiving the transaction code, the communication device activates a software application;
the software application providing to an operator of the communication device a request to process payment;
the operator granting the request to process payment on the communication device; and
the communication device transmitting the request to process payment to the vault server.

17. The method of claim 10, further comprising:
imprinting upon a physical representation of a payment method the identification code of a personal access vault in combination with a payment method identification code, the payment method identification code being different from the payment method account number;
providing to a payee the physical representation of the payment method;
the payee transmitting a payment request via at least one payment network server;
the payment network server utilizing the identification code of the personal access vault to determine the location to a vault server;
the payment network server transmitting a request for payment in combination with the payment method identification code to the vault server;
wherein none of the steps of the method comprise the payment method account number being printed upon the physical representation of the payment method.

18. The method of claim 17, further comprising:
upon receiving a payment request in combination with an identification code for a personal access vault and payment method identification code, the vault server determining the location of a personal access vault;
the vault server using the payment method identification code to determine the location of a payment remittance server;
the vault server transmitting a request to process payment to a payment remittance server;
wherein none of the steps of the method comprise the payment method account number being printed upon the physical representation of the payment method.

19. The method of claim 1, wherein the step of transmitting to a function server a request to restrict access to a function comprises:
providing the vault server identifying details of the function and requesting that the access to the function be restricted;
the vault server transmitting to the function server a request to restrict access to the function;
the function server receiving the request to restrict access and restricting access; and
the function server awaiting a permission from the vault server prior to performing the function.

20. The method of claim 1, wherein the step of transmitting to the function server a request to restrict access to a function, further comprises:
providing to a function server an identifying code for a personal access vault and requesting the function server to restrict access to a function;
upon receipt of the request, the function server transmitting a notification to a vault server that the function is in a restricted state;
the vault server transmitting a confirmation of receipt back to the function server; and
the function server providing to an operator an icon indicating the restricted status of the function.

21. The method of processing a payment of claim 7, further comprising:
in response to receiving a request to process payment, the payment remittance server checking the payment method account to determine whether the account is in a restricted status;
if the account is in a restricted status, the payment remittance server checking whether the amount of the payment requested is over a predetermined amount; and
if the payment requested is over a predetermined amount, the payment remittance server sending a request to the vault server to grant a permission.

22. The method of claim 9, wherein the step of either a payee or a payer transmitting the request to process the payment to either a payment remittance server or a vault server, further comprises:
the payer transmitting to a vault server a request to process a payment along with a identifying code for a payee personal access vault;
the payer vault server transmitting the request to process the payment along with the identifying code of the payee personal access vault to a payment remittance server;
the payment remittance server transmitting a request to the vault server hosting the payee personal access vault to transmit back an account identifying account code for the payee, the account code being different from the financial account number for the payee;
the payee vault server transmitting back the account code to the payment remittance server;
the payment remittance server utilizing the account code to determine the location of a payment acceptance server;
the payment remittance server transmitting payment to the payment acceptance server along with the identifying code for the personal access vault and the account code received from the vault server of the payee;
the payment acceptance server utilizing the identifying code of the personal access vault of the payee in combination with the account code to determine the financial account number for the payee; and
the payment acceptance server depositing the funds into the financial account of the payee;
wherein none of the steps of the method comprise the payment method account number of the payer or the financial account number of the payee being transmitted to or from any vault server, payment acceptance server, or payment remittance server and, in none of the steps is a stored value account or the assistance of any third party payment processor required to transmit payment from the account of the payer to the account of the payee.

23. The method of granting a permission to perform a function of claim 2, wherein a function may comprise one or more of the following:
sending a vault server a request to transmit a credit report;
sending the vault server a request to transmit a tax return;
sending the vault server a request to unlock a physical property;
sending the vault server a request to report a missing person; and
sending the vault server a request to enter a legal contract;
wherein the server processing the function does not have the authorization to process the function without first obtaining a permission from the vault server.
